(19) United States
(12) Patent Application Publication
(10) Pub. No.: US 2026/0300832 A1
(43) Pub. Date: Oct. 1, 2026

(54) Method and Apparatus for Supervised Training of an AI Foundation Model from Heterogeneously Labeled Datasets

(71) Applicants: DongAo MA, Tempe, AZ (US); Jiaxuan PANG, Tempe, AZ (US); Jianming LIANG, Scottsdale, AZ (US)

(72) Inventors: DongAo MA, Tempe, AZ (US); Jiaxuan PANG, Tempe, AZ (US); Jianming LIANG, Scottsdale, AZ (US)

(73) Assignee: Arizona Board of Regents on Behalf of Arizona State University, Scottsdale, AZ (US)

(21) Appl. No.: 19/633,875

(22) Filed: Mar. 30, 2026

Related U.S. Application Data
(60) Provisional application No. 63/781,892, filed on Apr. 1, 2025.

(51) Int. Cl. G06N 20/00

(52) U.S. Cl. CPC G06N 20/00

(57) ABSTRACT

Accruing and reusing information obtained from heterogeneously annotated labels associated with a plurality of medical image datasets to pretrain a model involves receiving the plurality of medical image datasets with the associated heterogeneously annotated labels, cyclically pretraining the model via a student encoder of a student-teacher learning model by iterating sequentially through the plurality of medical image datasets each round of pretraining to accrue knowledge from the associated heterogeneously annotated labels, and updating a teacher encoder of the student-teacher learning model each round of pretraining based on the student encoder's accrued knowledge.

### CLAIM OF PRIORITY

This application claims the benefit of U.S. Provisional Patent Application No. 63/781,892, filed Apr. 1, 2025, entitled “METHOD AND APPARATUS FOR ACCRUING AND REUSING KNOWLEDGE FOR SUPERIOR AND ROBUST FOUNDATION MODELS”, the disclosure of which is incorporated by reference herein in its entirety.

### GOVERNMENT RIGHTS AND GOVERNMENT AGENCY SUPPORT NOTICE

This invention was made with government support under R01 HL128785 awarded by the National Institutes of Health. The government has certain rights in the invention.

### COPYRIGHT NOTICE

A portion of this document contains material which is subject to copyright protection. The copyright owner has no objection to the facsimile reproduction by anyone of the document as it appears in the Patent and Trademark Office records but otherwise reserves all copyright rights whatsoever.

### TECHNICAL FIELD

Embodiments of the disclosure relate to a deep learning model that can be trained by aggregating numerous datasets, using a framework that accrues and reuses knowledge from heterogeneous expert annotations in the datasets.

### BACKGROUND

Deep learning offers expert-level and sometimes even super-expert-level performance, but achieving such performance demands massive, labeled data for training. For example, Google's proprietary CXR Foundation Model (CXR-FM) was trained on 821,544 labeled and mostly private chest radiographs (CXRs). Numerous datasets are publicly released in medical imaging. They are individually small and heterogeneous in terms of their expert labels, but collectively large.

### BRIEF DESCRIPTION OF THE FIGURES

Embodiments are illustrated by way of example, and not by way of limitation, and can be more fully understood with reference to the following detailed description when considered in connection with the figures in which:

FIG. 1A shows the disclosed embodiments built on a teacher-student model, augmented with multi-task heads (each corresponding to one task), and trained via cyclic pretraining.

FIG. 1B shows that in the distributed data approach, the disclosed embodiments adapt to a decentralized training environment.

FIG. 2 shows that a disclosed embodiment significantly outperforms both the supervised ImageNet model and MIM-CXR.

FIG. 3 provides visualizations that demonstrate the disclosed embodiments can identify diseased regions more accurately than other models.

FIG. 4A is a plot that demonstrates the disclosed embodiments achieve higher sensitivity (true localizations) with low false positive rates.

FIG. 4B demonstrates the disclosed embodiments surpass other models in mAP50, indicating the localizer fine-tuned is more accurate in detecting and localizing lesions with a bounding box overlap of at least 50% with the ground truth.

FIGS. 5A and 5B compare the disclosed embodiments with Google CXR-FM via linear probing on six target tasks, demonstrating the disclosed embodiments' superior performance and better embedding quality.

FIG. 6 compares the disclosed embodiments with Google CXR-FM on the pneumothorax classification task using linear probing with reduced training data or even few-shot samples.

FIGS. 7A and 7B show the disclosed embodiments demonstrate greater resilience to sex-imbalanced data from 1.CXPT and 2.NIHC, producing more unbiased results.

FIGS. 8A, 8B, 8C, 8D, and 8E illustrate performance trajectories for an ablated variant without the teacher model and consistency loss (with cyclic training), alongside those for the student model and teacher model of Ark+5 (with cyclic training) according to the disclosed embodiments.

FIG. 9 is a stacked bar chart that illustrates the label distribution among Ark+'s pretraining samples, aggregated across Datasets 1-6 in Table 2, presented in FIG. 13, in accordance with the disclosed embodiments.

FIG. 10 illustrates how data aggregation yields a more balanced age composition compared with individual datasets.

FIG. 11 presents an algorithm for one round of Ark+'s cyclic pretraining process, according to the disclosed embodiments.

FIG. 12 presents Table 1, which shows datasets created at different institutions tend to be annotated differently, even when addressing the same clinical issue.

FIG. 13 presents Table 2, which shows that publicly available datasets are generally small and heterogeneously annotated.

FIG. 14 presents Table 3, which shows how a family of Ark/Ark+ models were pretrained under various settings with different model architectures, datasets, and input resolutions, according to the disclosed embodiments.

FIG. 15 presents Table 4 which shows Ark+ models consistently outperform the SOTA fully/self-supervised ImageNet pretrained models on all target tasks, according to the disclosed embodiments.

FIG. 16 presents Table 5, which shows Ark+ models exhibit remarkable performance for the two long-tailed tasks, according to the disclosed embodiments.

FIG. 17 presents Table 6, which shows Ark+ models achieve significantly better performance than the SOTA models, demonstrating that Ark+ learned generalizable representations for delineating organs, bones and various thoracic diseases visible at CXR, according to the disclosed embodiments.

FIG. 18 presents Table 7, which shows results of training Ark+ with data distributed across multiple clients, according to the disclosed embodiments.

FIG. 19 presents Table 8, which illustrates a performance comparison of distributed Ark+ scaled to the Swin-Large backbone (768×768), evaluated under two distributed settings (6-client and 3-client), alongside centralized and isolated (local) training baselines.

FIG. 20 presents Table 9, which illustrates that Ark+ maintains high performance diverse architectural choices, according to the disclosed embodiments.

FIG. 21 presents Table 10, which shows that Ark6_{fundus} surpasses the SOTA scores on the internal tasks by a significant margin, and achieves superior or comparable performance on the unseen tasks, according to the disclosed embodiments.

FIG. 22 presents Table 11, which shows ablation studies evaluating the contribution of three key design components in Ark+ (a-c) and examining the influence of two additional factors (d-e) on its overall performance.

FIG. 23 presents Table 12, which illustrates an ablation study comparing multi-task heads with a single-task head, in which consolidated labels from Datasets 1-5 in Table 2 were manually consolidated into a predefined, manually assembled label list.

FIG. 24 presents Table 13, which summarizes the patient sex distribution across the pretraining datasets, providing context for analysis of sex-related bias.

FIG. 25 presents Table 14, which illustrates disaggregate results on 2.NIHC (ChestX-ray14).

FIG. 26 presents Table 15, which illustrates disaggregate results on and 9.CHDR to provide disease-specific performance insights.

FIG. 27 presents Table 16, which illustrates the sensitivity values at different false positive per image (FP/img) operating points derived from the FROC curves.

FIG. 28 presents Table 17, an overview of fundus photography datasets and tasks used for pretraining and evaluating Ark+6_{Fundus}. demonstrating Ark+'s modality-neutral property, according to the disclosed embodiments.

### WRITTEN DESCRIPTION

The disclosed embodiments present a powerful and robust AI foundation model trained in a supervised manner by aggregating numerous public, labeled datasets. The disclosed embodiments overcome a long-standing barrier of label heterogeneity across the datasets to be used for the supervised training of a single model. To this end, the disclosed embodiments present Ark+, a framework that Accrues and Reuses Knowledge from heterogeneous expert annotations associated with various datasets. To demonstrate the capability of Ark+, a family of Ark+ models was pretrained, including Ark+5 and Ark+6 on 335,484 and 704,363 CXRs, respectively, by merging multiple public datasets including MIMIC-CXR, CheXpert, ChestX-ray14, RSNA Pneumonia, VinDr-CXR, and Shenzhen-CXR. The two Ark+ models were trained on a wide range of imaging tasks covering classification, segmentation, and localization via fine-tuning, linear-probing, and sex-bias analysis, and demonstrated Ark+'s superior and robust performance over the state-of-the-art fully/self-supervised baselines and Google's proprietary CXR-FM. Ark+ has several distinctive and advantageous properties by design. A series of ablation studies show the contribution from each of its components and its superiority over alternative strategies. To demonstrate its' capabilities of incorporating privacy-preserving data and addressing heterogeneous annotations across private clients in federated learning, Ark+ was simulated in various distributed training environments. To highlight its independence of architecture and scalability in image resolution, two Ark+6 models with different architectures in different resolutions were developed. To assess its neutrality in imaging modality and extensibility to different modalities, an Ark+ model was pretrained on fundus photography. The enhanced performance of Ark+ is attributable to the simple yet powerful insight: aggregating various datasets diversifies patient populations and accrues knowledge from many experts, yielding unprecedented performance while simultaneously reducing annotation costs. Given the ubiquity of heterogeneous data and labels across disciplines including biology, chemistry, physics, medicine, and the social sciences, the concept underlying Ark+ is poised to have far-reaching implications beyond imaging. Ark+ demonstrates that accruing and reusing knowledge from expert annotations in even only public datasets can surpass the performance of proprietary models trained on unusually large data.

### 1. INTRODUCTION

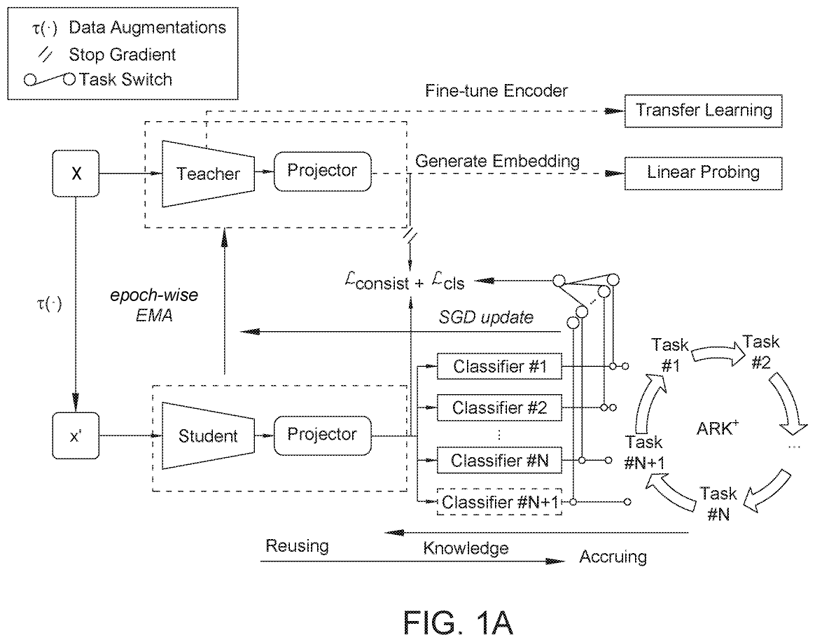

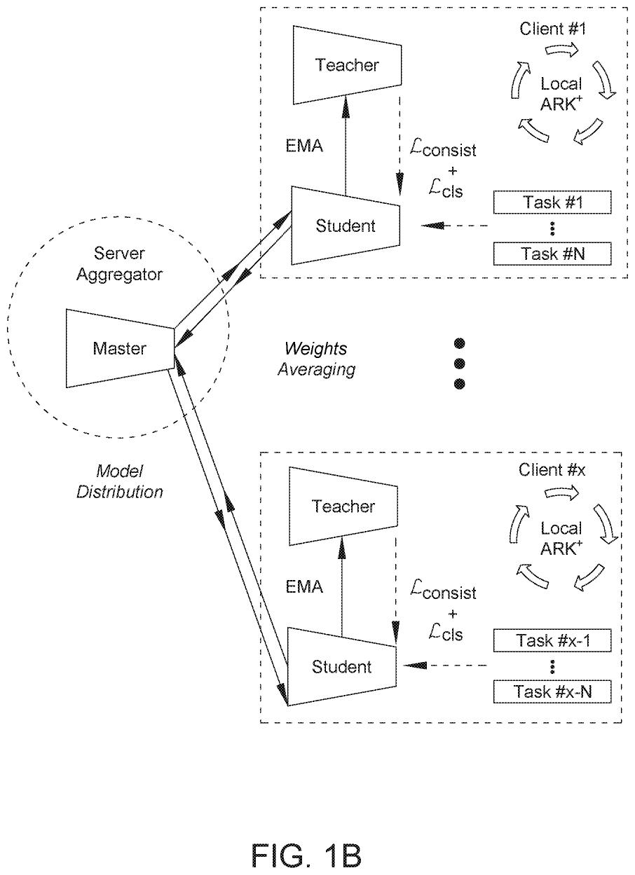

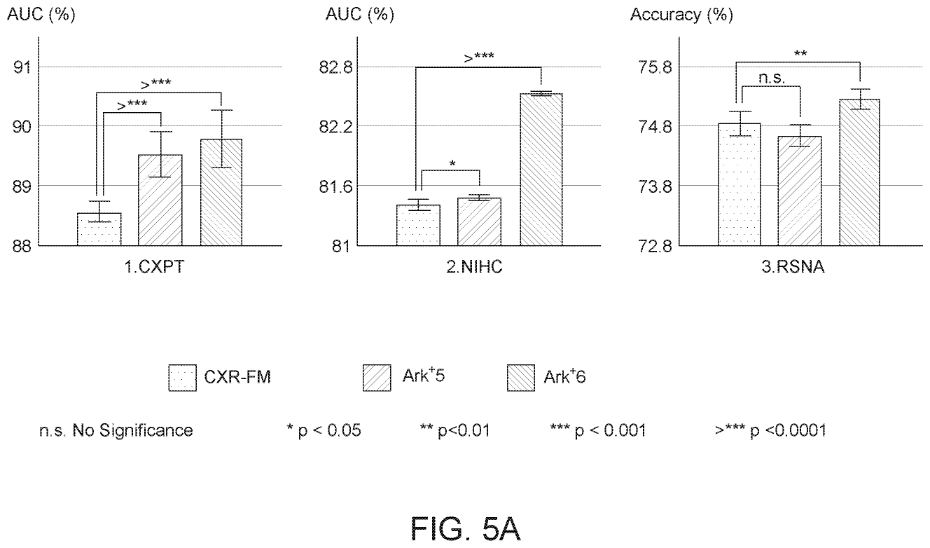

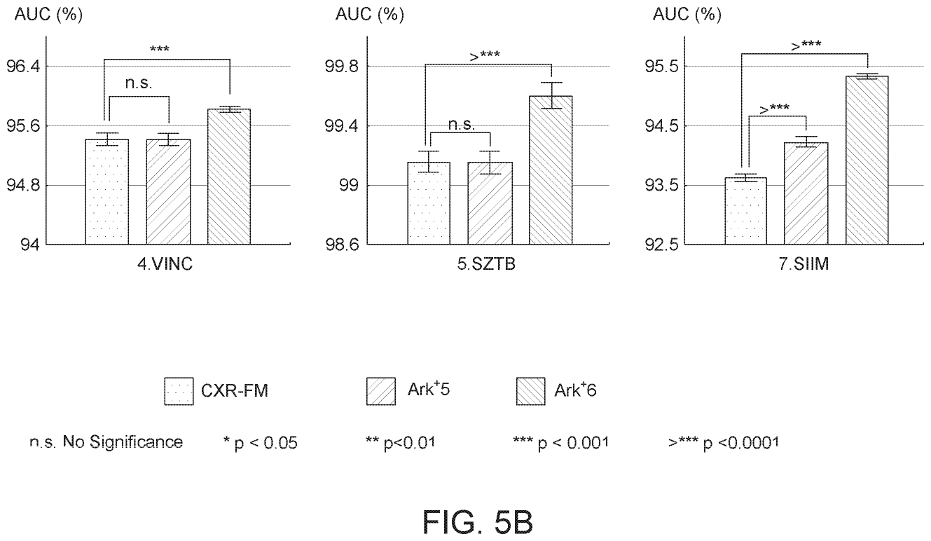

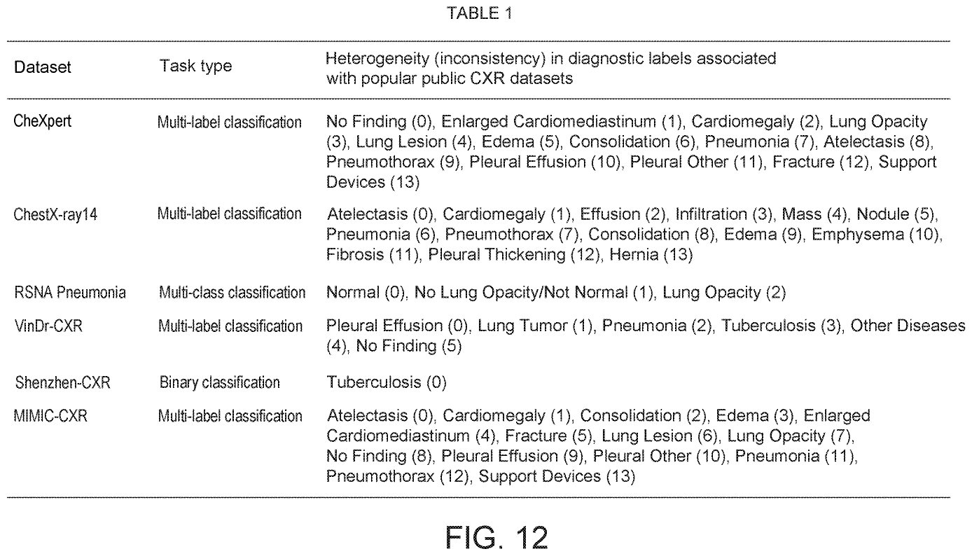

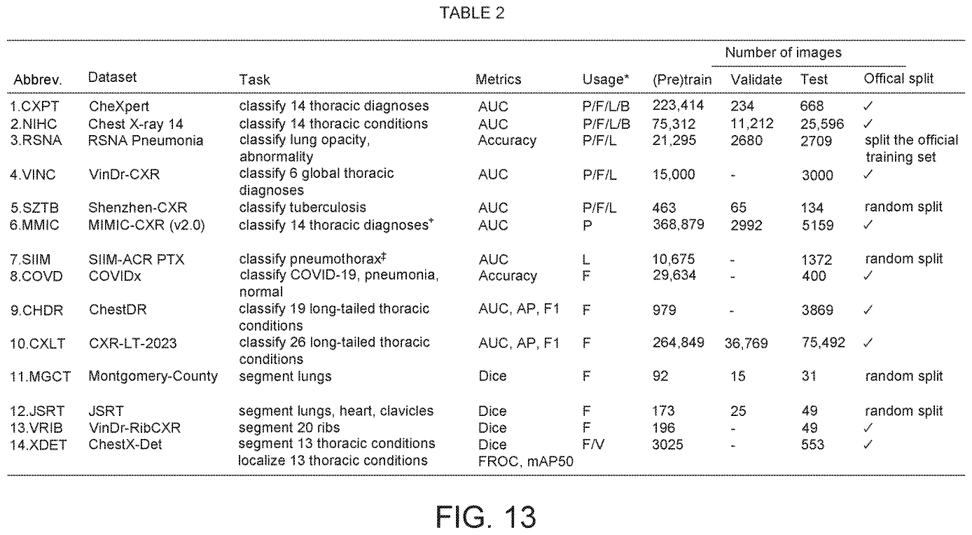

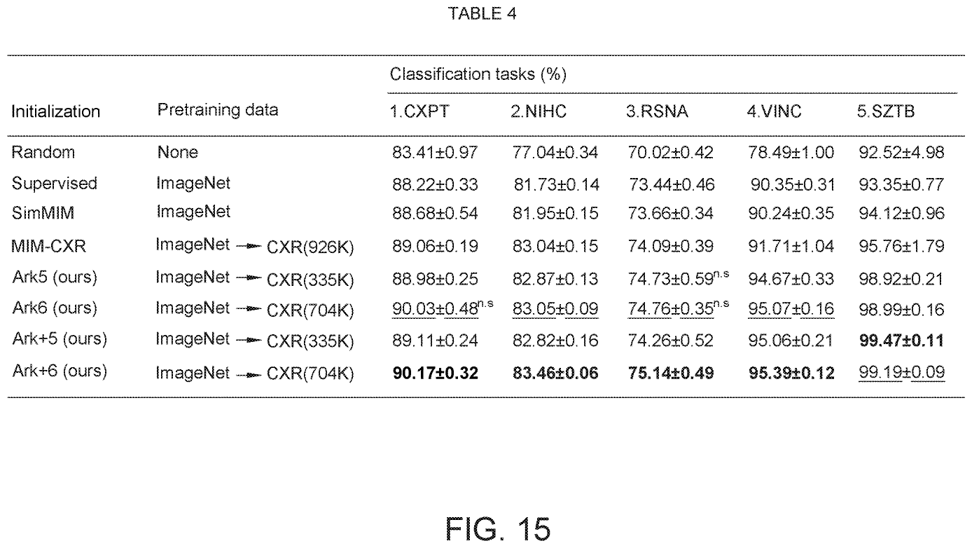

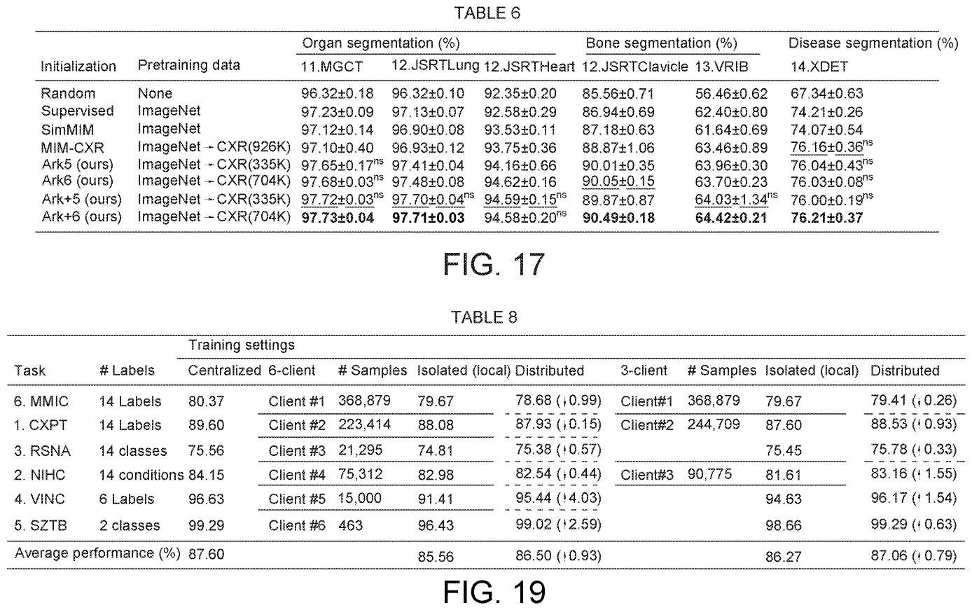

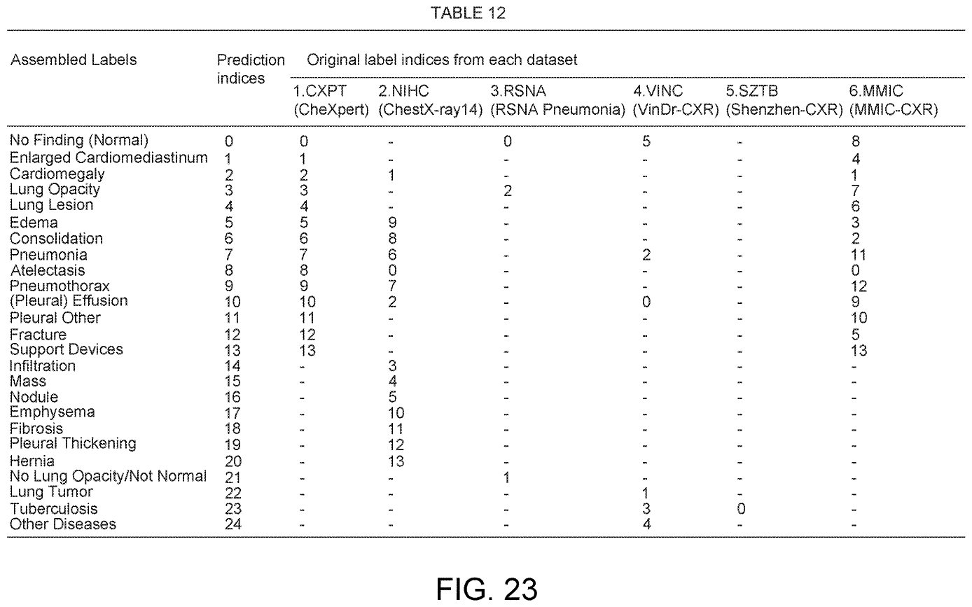

Deep learning offers expert-level, possibly even super-expert-level performance, for a wide range of tasks previously performed by human observers, resulting in rapid and widespread adoption in various aspects of medical practice, most notably medical imaging. The success of deep learning models for medical applications has resulted in the rapid proliferation of numerous public medical imaging datasets for research, competitions, and challenges. These datasets are generally small as annotating medical images is challenging, but achieving superior performance by deep learning demands massive, annotated data for training. For example, Google's proprietary CXR Foundation Model (CXR-FM) was trained on 821,544 labeled and mostly private chest radiographs (CXRs). It is hypothesized that powerful and robust open foundation models can be trained by aggregating numerous small public datasets. To test this hypothesis, chest radiography was chosen because it is the most frequently used imaging modality, and the research community has accumulated many CXRs. See Table 2 presented in FIG. 13. Table 2 shows that publicly available datasets are generally small and heterogeneously annotated. Ark+ (FIGS. 1A and 1B) aggregates numerous such labeled datasets, enlarging training data, expanding diagnostic diseases, broadening imaging protocols, diversifying patient populations, accruing knowledge from many experts, and addressing the deep learning demand for massive, annotated training data, thereby offering superior and robust performance while simultaneously reducing annotation cost. The usage of each dataset in the experiments is denoted with P for pretraining, F for fine-tuning, L for linear probing, B for bias study, and V for visualizing the Grad-CAM. The labels of CXRs in MIMIC-CXR are derived from their corresponding radiology reports using CheXpert. SIIM-ACR, originally for pneumothorax segmentation, is converted into a classification task for linear probing, as CXR-FM cannot be evaluated for segmentation using its only released API. However, annotations associated with these public datasets are inconsistent in terms of disease coverage. See Table 1 presented in FIG. 12. Table 1 shows datasets created at different institutions tend to be annotated differently, even when addressing the same clinical issue. Ark+ represents an innovative solution for training one high-performance model from many datasets with different labels. More specifically, Ark+ accrues and reuses expert knowledge from numerous datasets with heterogeneous labels in fully supervised fashion to pretrain generic source models that are more robust, generalizable, and transferable to application-specific target tasks, yielding superior and robust performance compared with the state-of-the-art fully/self-supervised baselines (Tables 4 (FIG. 15) and 6 (FIG. 17) and Google CXR-FM (FIGS. 5A and 5B). The challenge of learning from heterogeneous labels is addressed in Ark+ via multi-task heads and cyclic pretraining (FIGS. 1A and 1B). To facilitate the ablation study in Section 5.8.2 (Table 12, FIG. 23), each label is associated with an index to indicate the original order of labels in each of the listed datasets. Even when addressing the same clinical issue, datasets created at different institutions tend to be annotated differently. FIG. 23, Table 12, illustrates an ablation study comparing multi-task heads with a single-task head, in which consolidated labels from Datasets 1-5 in FIG. 13 were manually consolidated into a predefined, manually assembled label list. A single classification head with an output dimension of 25 was initialized, with each dimension corresponding to a prediction index in the consolidated list. The numbers in each column of the datasets indicate the original order (indices) of labels with that dataset (see FIG. 12). For example, “atelectasis”, which has an original index of “0” (i.e., the first label) in 2.NIHC (ChestX-ray14), maps to index “8” in the consolidated label list. During training, the loss was computed by aligning original label indices with their corresponding prediction indices, while ignoring all other outputs, denoted by “−”. For example, VinDr-CXR is associated with global (image-level) and local (boxed-lesions) labels, while MIMIC-CXR has no expert labels per se but is associated with radiology reports. ChestX-ray14 and CheXpert each cover 14 conditions at the image level. However, although the conditions evaluated in these two datasets overlap to some degree, they are not identical. Therefore, there is a critical need: How can the large number of publicly available images with their readily accessible, albeit heterogeneously labeled, expert annotations from different sources be employed to pretrain a single general-purpose foundation model that is more robust and transferable to application-specific target tasks?

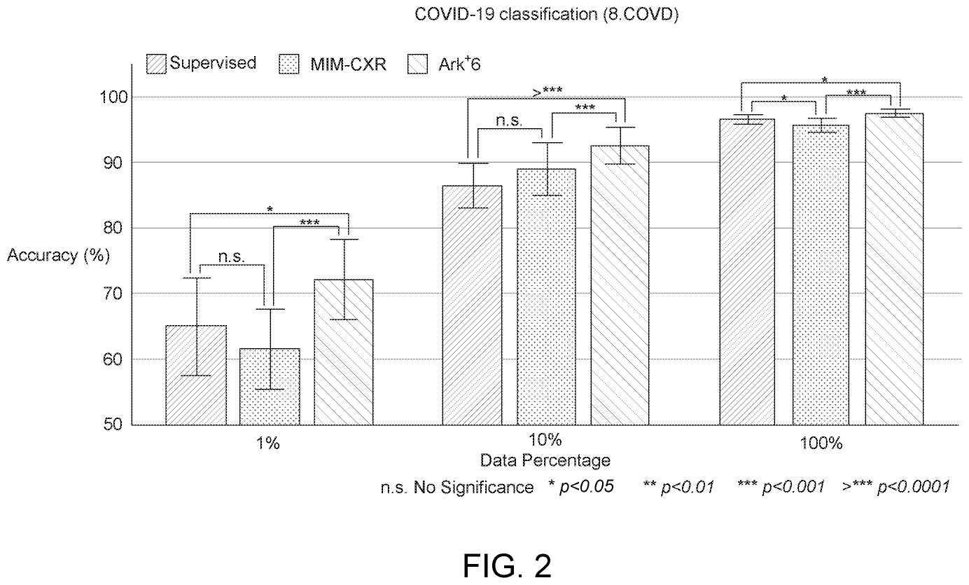

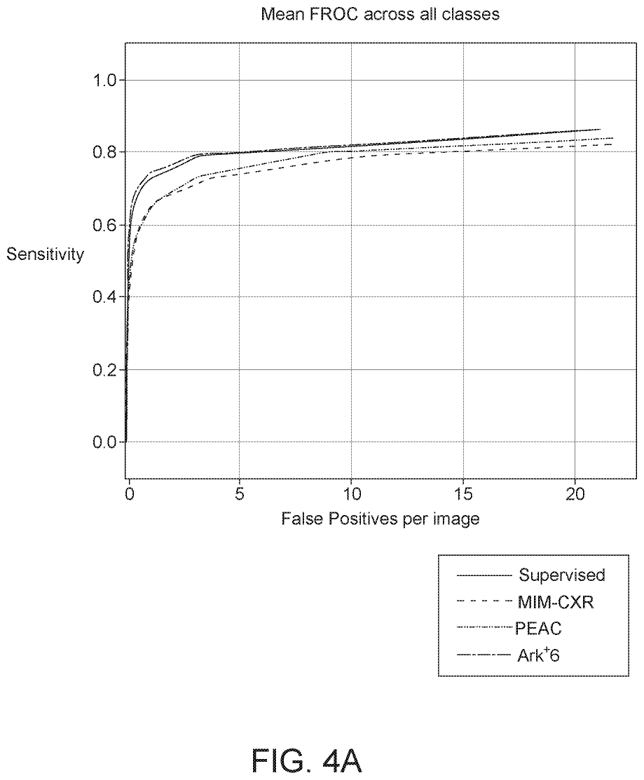

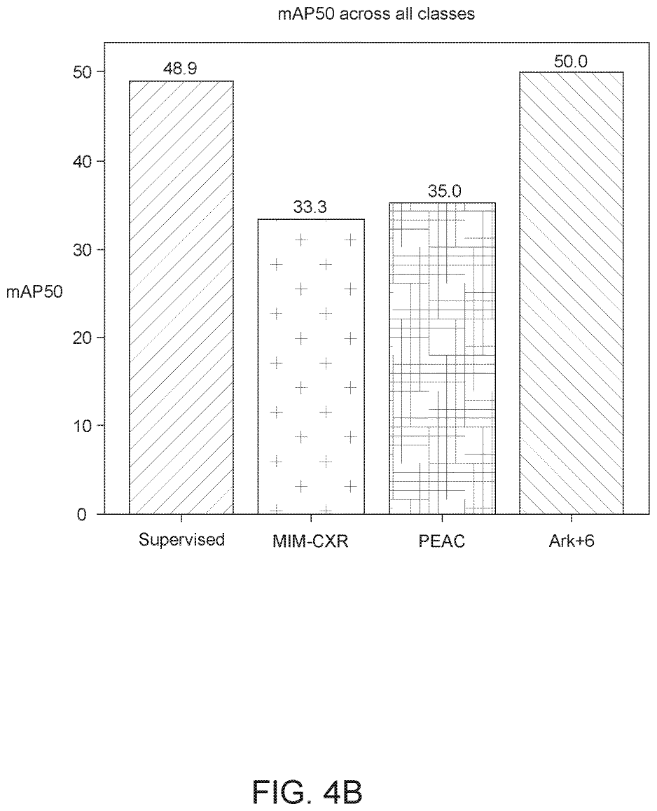

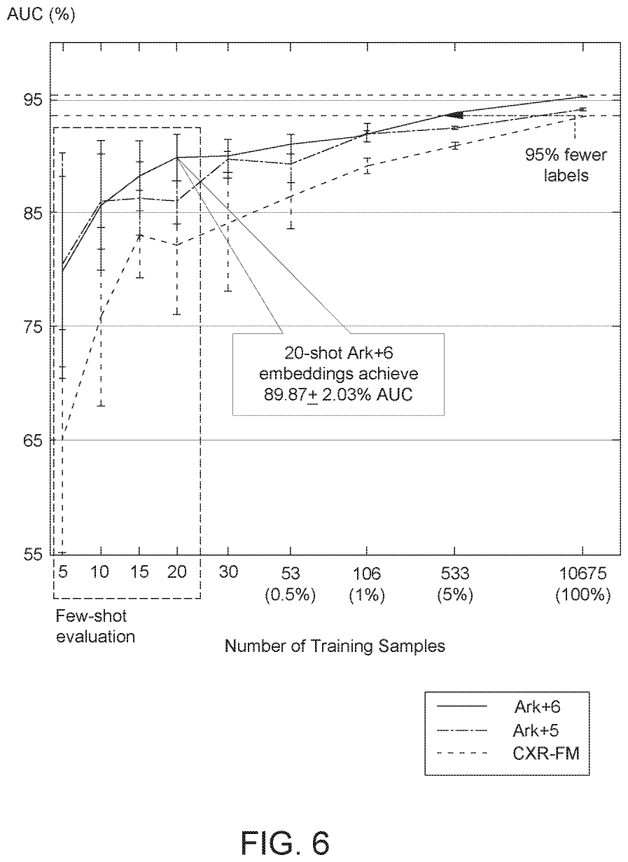

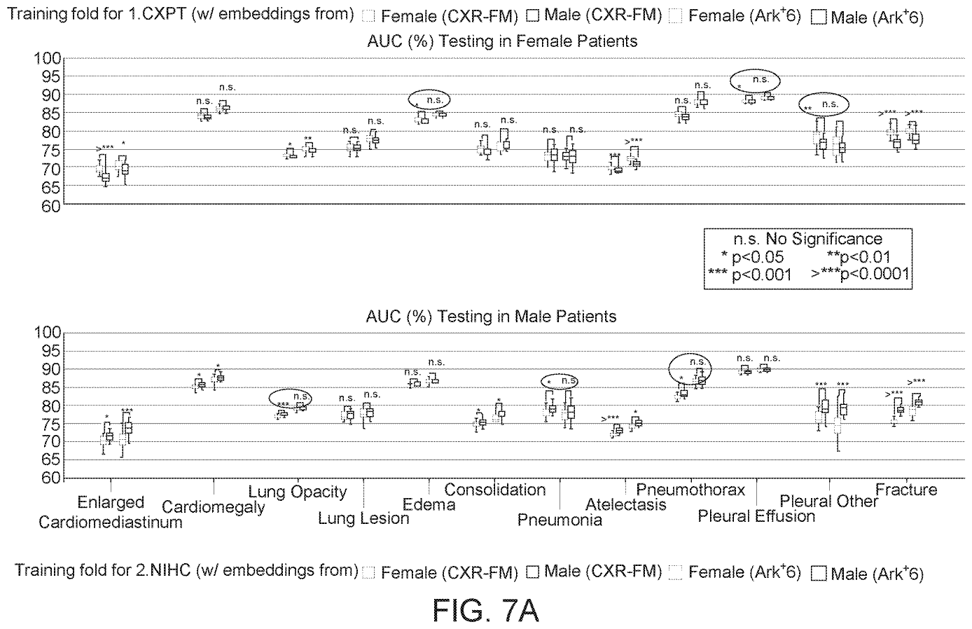

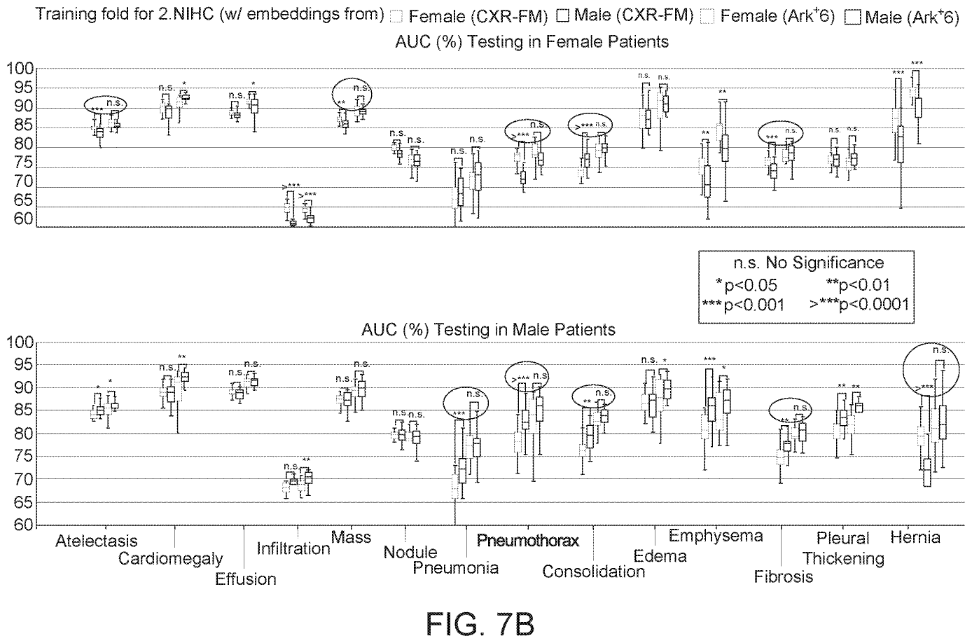

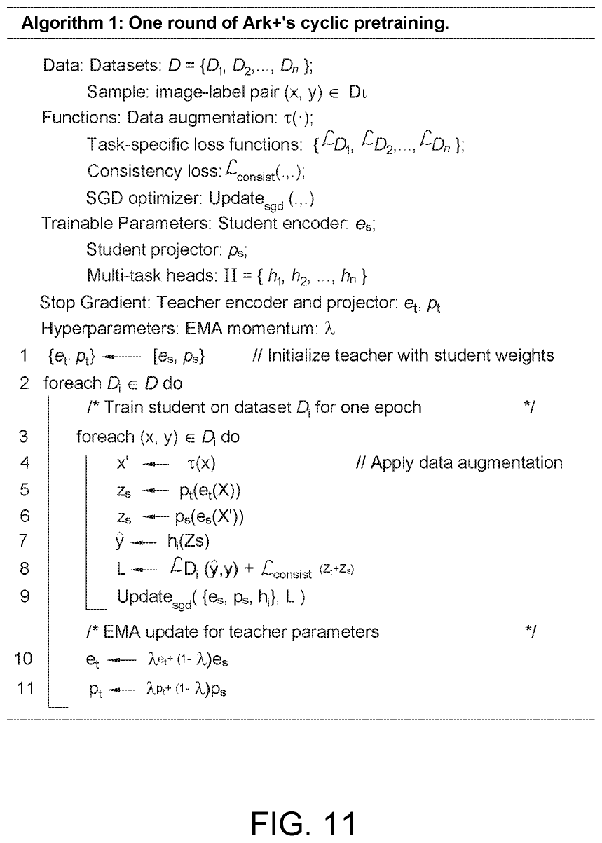

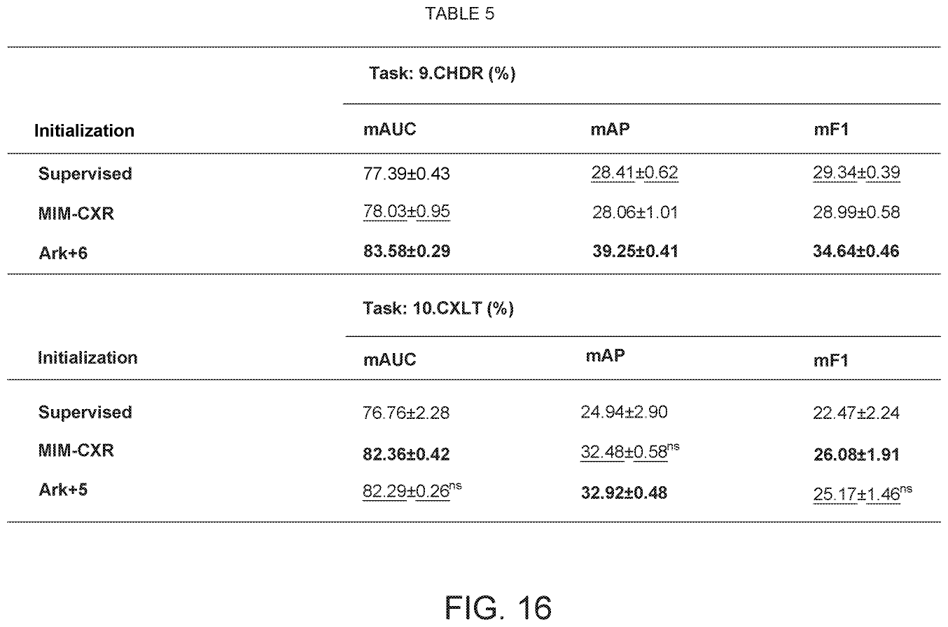

To meet this critical need, the disclosed embodiments provide a framework, called Ark+ for its inherited and enhanced ability from Ark of accruing and reusing knowledge embedded in heterogeneous expert annotations with numerous datasets, as illustrated in FIGS. 1A and 1B. FIGS. 1A and 1B illustrate Ark+'s pretraining using (a) centralized data and (b) distributed data. FIG. 1A shows Ark+ is built on a teacher-student model, augmented with multi-task heads (each corresponding to one task), and trained via cyclic pretraining. Cyclic pretraining is an iterative process: At each iteration, the student accrues knowledge via a classification loss ( [symbol] ) from every expert annotation through its corresponding task head by sequentially scanning all datasets (tasks) one by one for a single round. At the end of each task (one epoch), the knowledge accrued by the student is accumulated by the teacher via exponential moving average (EMA) and reused to help the student accrue more knowledge from the expert annotations associated with the next dataset (task). To reinforce the feedback loop between the student and teacher, after their encoders, a projector is introduced to map the representations to the same feature space via the consistency loss ( [symbol] ). The Ark+ pretraining process for each round is outlined in the algorithm presented in FIG. 11. After pretraining, the accrued knowledge in the teacher can be reused and transferred to target tasks. Differing from the previous Ark design, the teacher model is supplied with the resized original image (x) rather than random cropping. This data augmentation update ensures the teacher provides a consistent and steady supervisory signal for computing the consistency loss, thereby accelerating training and enhancing performance. FIG. 1B shows, in the distributed data scenario, Ark+ adapts to a decentralized training environment whereby multiple client nodes independently collect and preprocess data locally, preserving data privacy and reducing the need for centralized data storage. Each client node pretrains its own local Ark+ models using its respective data, employing the same cyclic pretraining strategy to train the student and the same epoch-wise EMA to update the teacher. Once a round of local training is completed, these client nodes send the weights of their student models (including the encoder and, optionally, the task heads) to a central server. The central server aggregates these local models into a “master” model (e.g., averaging the weights), thereby synthesizing the diverse knowledge from all clients. This aggregated master is then distributed back to the client nodes, where the process iterates, allowing continuous learning and improvement for the local teacher models. For simplicity, the projectors and multi-task heads are not illustrated. This distributed approach not only leverages the computational resources of client nodes but also enhances the scalability and robustness of the Ark+ training pipeline. To demonstrate Ark+'s capabilities, two models were pretrained: Ark+5 on Datasets 1-5 and Ark+6 on Datasets 1-6 shown in FIG. 13, Table 2. These two models were evaluated on a wide range of 13 tasks via fine-tuning and on 6 tasks via linear probing. Extensive experiments show that Ark+ models consistently out-perform the state-of-the-art (SOTA) fully/self-supervised baselines (Tables 4 and 6 and FIGS. 2 and 4) and Google CXR-FM (FIG. 6). Ark+ also demonstrates robustness in handling long-tailed distributions of data and in tolerating sex-related bias, showing greater resilience to both imbalanced condition prevalence and sex-exclusive training data compared with the SOTA baselines (FIG. 16, Table 5 and FIG. 7).

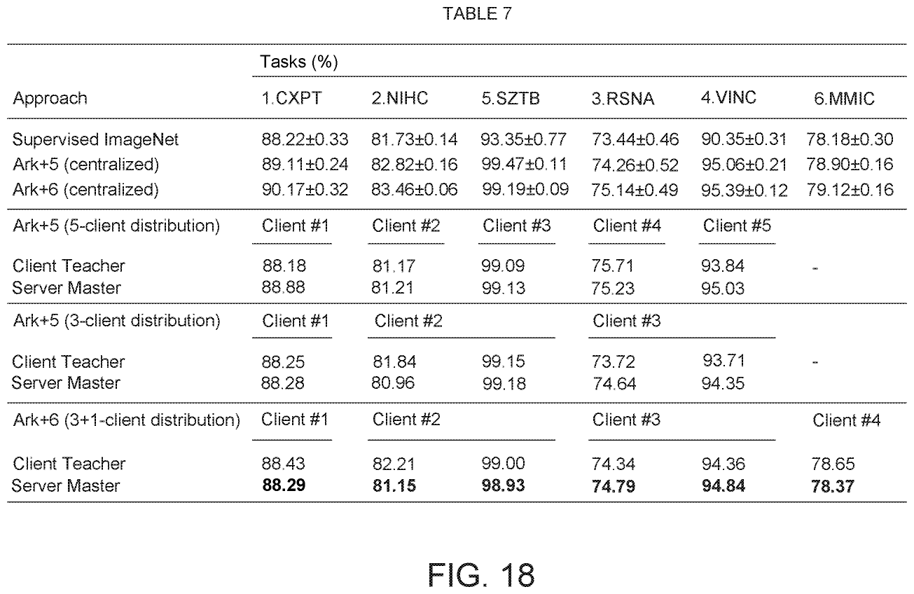

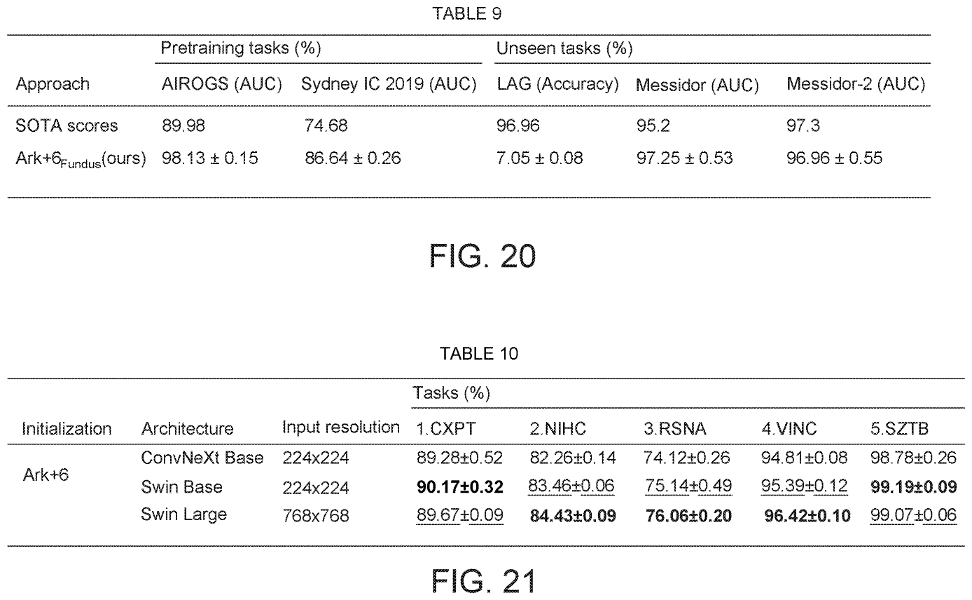

Ark+, by design, possesses several distinctive and advantageous properties, as detailed in Section 2.5. For example, to show its independence of architecture and scalability in image resolution, two additional Ark+6 models were pretrained with different architectures in different resolutions (Table 9 presented in FIG. 20). To evaluate its neutrality in imaging modality and extensibility to different modalities, a new Ark+ model was pretrained on fundus photography (Table 10 presented in FIG. 21). To demonstrate its capabilities of preserving private data and utilizing heterogeneous annotations across private clients in federated learning, Ark+ was simulated in various distributed training environments (FIGS. 18, Table 7 and FIG. 19, Table 8).

Ark+ represents a methodological breakthrough for learning one high-performance model from a multitude of datasets with different labeling schemes. It agglomerates various (big or small and public or private) datasets and their associated heterogeneous labels for fully supervised learning, demonstrating remarkable clinical value in expanding the diagnostic scope, correcting potential misdiagnosis, adapting to evolving diagnostic needs, handling long-tailed diseases, learning rare conditions from a few samples, transferring to new diagnostic settings without training, and responding to novel diseases. To show its technological novelties and innovations, Ark+ will be contrasted with the SOTA methods reported in the literature with details in Section 7 (related work). Most important, Ark+ is fundamentally different from self-supervised learning (SSL) and federated learning (FL) in concept (detailed in Section 7). SSL can naturally handle images from different sources; however, their associated expert annotations are excluded from pretraining, which omits critically important expert knowledge embedded within these annotations. FL can utilize data with annotations from different sources, typically involving only homogeneous labels, but it primarily focuses on preserving data privacy. By contrast, Ark+ targets heterogeneous expert annotations in publicly available datasets, where privacy constraints are minimal, and employs centralized training, which typically yields better performance than distributed training under equivalent data and annotation conditions. Although Ark+ is designed for centralized pretraining by default, its effectiveness is demonstrated in distributed scenarios across multiple clients, highlighting its potential to enable FL to handle heterogeneous annotations across private clients, a capability novel to conventional FL.

Ark+'s performance enhancement is attributable to the simple yet powerful observation that aggregating numerous public datasets is practically cost-free but substantially enlarges data size, expands imaging protocol coverage, diversifies patient populations, and accrues expert knowledge from many sources worldwide, thereby enabling unprecedented performance while reducing annotation cost. Ark+, includes several important technical contributions:
1. An innovation in machine learning that trains one high-performance model using a multitude of datasets that are labeled differently.
2. A new idea that aggregates public datasets to enlarge and diversify training data and utilize their heterogeneous labels for fully supervised learning.
3. A novel methodology that exploits a student-teacher model with multi-task heads via cyclic pretraining to accrue and reuse expert knowledge from existing heterogeneous labels associated with numerous datasets to achieve superior and robust performance while reducing annotation cost.
4. A proof of concept that enables federated learning to effectively handle heterogeneous annotations while preserving private data locally and distributing pretraining across many clients.
5. Detailed analyses reveal the distinguishing properties of Ark+: knowledge-centric, annotation-heterogeneous, label-agnostic, task-scalable, function-extensible, prediction-extensive, training-distributable, client-expandable, architecture-independent, resolution-scalable, modality-neutral, and application-versatile.
6. Thorough ablation studies examine the contributions by each of the three key components in Ark+ and the influence of alternative strategies, including the single-task head, concurrent pretraining, dataset visitation orders, and data scales.
7. Comprehensive experiments that evaluate Ark+ via fine-tuning, linear-probing, few-shot learning, and bias analysis on a variety of target tasks, demonstrating Ark+'s improved generalizability, transferability, and robustness compared with SOTA methods and Google CXR-FM.

The remainder of this disclosure is organized as follows: Section 2 describes the Ark+ framework, methodology, and its distinctive properties to show the novelties of Ark+. Sections 3 and 4 detail experimental settings for pretraining and evaluation, respectively. Section 5 presents results and analysis. Section 6 discusses key findings, limitations, and future work. Section 7 reviews related work to highlight innovations of the embodiments disclosed herein. Finally, Section 8 discusses broader impacts.

### 2. ACCRUING AND REUSING KNOWLEDGE

Ark+ develops foundation models of superior and robust performance in medical imaging using a multitude of datasets annotated under diverse labeling schemes in a fully supervised manner. It learns from large-scale aggregated medical images by accruing and reusing the expert knowledge embedded in heterogeneous labels across datasets. FIG. 1A depicts the Ark+ pretraining framework, which is built on (1) a teacher-student model augmented with (2) multi-task heads (each head corresponding to one task) and trained via (3) cyclic pretraining. The following sections provide detailed insights regarding the Ark+ framework, followed by a summary of its distinctive properties.

2.1. Accruing Knowledge into the Student Via Cyclic Pretraining

A significant challenge with training a single model using numerous datasets created for different tasks is label inconsistency (i.e., heterogeneity). See Table 1, FIG. 12. Manually consolidating heterogeneous labels from different datasets (e.g., FIG. 23, Table 12) is laborious and error prone. To circumvent this issue, specific classifiers, called task heads, are introduced for each task to learn from the available annotation and encode the knowledge into the model. These task heads can be easily plugged into Ark⁺, making it scalable to additional tasks. With multi-task heads, Ark⁺ can learn from multiple tasks concurrently or cyclically.

Concurrent pretraining involves updating the model using a combined loss from all tasks, which can lead to conflicting gradients during back-propagation. This conflict may weaken the overall gradient signal, causing slower convergence and suboptimal performance. By contrast, cyclic pretraining allows the model to focus on one task at a time in each iteration, reducing gradient interference and promoting more efficient learning. To demonstrate the effectiveness of cyclic pretraining and validate the design choice, an ablation study was conducted, with comparative results presented in Section 5.8.3.

2.2. Accruing Knowledge into the Teacher Via Epoch-Wise EMA

To further summarize the accrued knowledge and accumulate the learning experiences over time, a teacher model is introduced into Ark⁺ that shares the same architecture as the student. The teacher is updated using exponential moving average (EMA) based on the student's one epoch of learning at the end of each task. This means that the teacher model incorporates the expert knowledge embedded in all labels and all historical learning experiences, making it a repository of accrued knowledge for reuse in cyclic pretraining and for application-specific target tasks. The EMA is defined as:

$${θ}_{e}^{t} = α {θ}_{e}^{s} + ( 1 - α ) {θ}_{e - 1}^{t} \qquad ( 1 )$$

Where θ^{t}ₑ and θ^{t}ₑ represent the updated parameters of the teacher model and the student model, respectively, at epoch e, θ^{t}ₑ₋₁ represents the parameters of the teacher model at the previous epoch, and α is the smoothing factor (0<α<1). The parameter α determines the weight given to the current student's parameters and the previous teacher's parameters. A higher α places more emphasis on the current student's parameters, while a lower α gives more weight to the past teacher's parameters.

2.3. Reusing Accrued Knowledge from the Student to Bolster Cyclic Pretraining

When the model learns from multiple tasks sequentially, it may “forget” the previously learned knowledge, leading to degraded performance on earlier tasks. This problem is specifically addressed by Ark⁺ through cyclic pretraining, where the model revisits all the tasks in each round and reuses all knowledge accrued from the previous rounds and tasks to strengthen its learning from the current and future tasks. In other words, by regularly reviewing accrued knowledge through task revisitation, Ark⁺ not only prevents forgetting but also enables more efficient and effective learning from multiple tasks iteratively.

2.4. Reusing Accrued Knowledge from the Teacher to Mitigate Forgetting

To leverage the accumulated knowledge of the teacher model as an additional self-supervisory signal, a consistency loss between the student and the teacher was incorporated, as shown in FIG. 1A. To enhance this supervision, projectors are introduced in Ark⁺ that map the outputs of the student and teacher encoders to the same feature space. This further reinforces the feedback loop between the student and teacher models, facilitating the transfer of historical knowledge from the teacher to the student as a reminder, thereby mitigating forgetting.

### 2.5. Distinctive Properties of ARK⁺

Knowledge-centric. Annotating medical images by radiologists for deep learning is a process of transferring their in-depth interpretation knowledge and expertise into a medium from which computers can learn Ark⁺'s superior and robust performance results from the ability to exploit the accumulation of expert knowledge conveyed through medical imaging annotations from diverse expert sources worldwide. At the core of Ark+ is the ability to acquire and share knowledge: “knowledge is power” (Sir Francis Bacon) and “power comes not from knowledge kept but from knowledge shared” (Bill Gates).

Annotation-heterogeneous. Different institutions and annotators often adopt varying definitions of label granularity and follow distinct annotation standards, leading to heterogeneous annotations across datasets. To effectively accommodate this heterogeneity, Ark+ is intrinsically designed to be “label-agnostic.” This property enables researchers to best utilize their expertise in establishing new standards and annotating datasets at their preferred granularities.

Label-agnostic. Ark⁺ is label-agnostic as it does not require prior label “harmonization” of (public or private) datasets, such as analyzing, interpreting, or reconciling differing label definitions across datasets, but instead uses their originally provided labels as-is. This property empowers researchers to design and annotate datasets in the way they deem most appropriate for their specific tasks, without being constrained by the need to conform to a standardized label taxonomy.

Task-scalable. Ark+ incorporates pluggable multi-task heads and cyclic pretraining, enabling flexibility and scalability in adding new tasks anytime “on the fly” during pretraining without the need for manually consolidating heterogeneous labels or retraining dedicated task-specific controllers or adapters. This property allows researchers to create new datasets at their own pace for collaborative development and incremental training of foundation models.

Function-extensible. Ark+ is not limited to classification tasks; its underlying design can be naturally extended to support different types of vision tasks (function) such as localization, segmentation, and their integration. This property allows researchers to contribute annotations for any imaging tasks and build unified models capable of handling a variety of medical imaging tasks within a single framework.

Prediction-extensive. Ark+ expands the predictive scope beyond that of any individual dataset by learning from a multitude of heterogeneous, partially labeled datasets. The union of labels across these datasets defines a more comprehensive annotation space (see FIG. 23), which is effectively captured through Ark+'s multi-task heads. This property enables the model to deliver broader diagnostic coverage and enhanced predictive completeness, yielding more comprehensive and accurate results. This property also encourages experts around the world to collaborate and provide complementary annotations.

Training-distributable and client-expandable. Although the default setting of Ark⁺ involves pretraining with centralized data, it is also designed to support distributed training. See FIG. 1B, Section 3.3, and Table 7 presented in FIG. 13. This approach allows data to be maintained locally on client nodes, sharing only the model weights with a central server for aggregation. This method not only preserves private data but also leverages the computational resources of multiple clients, potentially facilitating federated learning to effectively handle heterogeneous annotations. Additionally, Ark⁺ is client-expandable, seamlessly integrating new clients and their data into the training process without degrading performance, thereby enhancing scalability and robustness. This property empowers researchers and institutions to publicly release data, federate privacy-preserving data, utilize both public and federated private data, and collaboratively build robust, large-scale, high-performance foundation models over time, even as data availability evolves.

Architecture-independent and resolution-scalable. Ark+ is architecture-neutral, maintaining high performance across a variety of model architectures such as Swin Transformer and ConvNeXt under both centralized and distributed configuration (see FIGS. 19 and 20). This flexibility allows Ark+ to leverage advancements in different neural network architectures without being confined to a specific architecture. This enables the extension of Ark+ to various modalities (e.g., CT, MRI, videos, audios, tables, and text) and multimodal clinical data. Additionally, Ark+ can accommodate higher input resolutions to achieve even better results, demonstrating its adaptability and scalability. This property allows researchers and practitioners to flexibly choose or upgrade backbone architectures based on evolving hardware capabilities, task requirements, or resource constraints, without the need to redesign the pretraining framework.

Modality-neutral. The idea underlying Ark+ is not limited to chest radiography; its modular design allows the backbone to be replaced or adapted for other data modalities such as CT and fundus photography (Table 10 presented in FIG. 21). This property allows researchers and clinicians to leverage the same robust learning framework for developing foundation models across diverse medical contexts. For example, AI specialists for particular organs (e.g., brain and fundus), specialties (e.g., pathology and dermatology), and modalities (e.g., CT and MRI) and AI generalists for medicine trained with multimodal clinical data including text, tables, audios, images, and videos.

Application-versatile. Ark⁺ trains versatile foundation models by utilizing a large number of (public or private) images from diverse sources and their readily accessible diagnostic labels. As shown in Section 5, Ark⁺ models are more robust, generalizable, and transferable to a wide range of application-specific target tasks across various imaging findings and diseases (e.g., pneumothorax, tuberculosis, cardiomegaly) and anatomies (e.g., lung, heart, rib). Ark⁺ is also extensible to different imaging modalities (e.g., chest radiography, fundus photography), highlighting its versatility.

### 3. PRETRAINING ARK⁺

3.1. Pretraining with Centralized Data

To demonstrate the scalability of Ark+ in incorporating additional datasets, two models were independently trained: Ark+5 and Ark+6. Ark+5 was pretrained on 335,484 CXRs from the training sets of Datasets 1-5 listed in Table 2, FIG. 13, visiting each dataset in the listed order. These datasets were collected by different institutions worldwide and annotated by their respective experts. Ark+6 was pretrained on 704,363 CXRs, incorporating an additional dataset (i.e., 6.MMIC), using a cyclic pretraining schedule in the order: Dataset 6, 1, 2, 3, 4, and 5. The dataset visitation order follows an intuitive strategy of progressing from larger to smaller datasets. The disclosed embodiments used the originally provided labels (Table 1, FIG. 12), which show marked differences across institutions. To prevent test-image leaks, all validation and test data are excluded from Ark+'s pretraining.

The disclosed embodiments employ the base version of the Swin transformer with an input resolution of 224×224 as the backbone. The teacher and student model encoders were both initialized with the officially released weights trained on ImageNet, and the projectors and the multi-task heads were randomly initialized. The task-specific (classification) loss was associated with each dataset based on its labels. Binary cross-entropy was used for the binary/multi-label classification tasks (Datasets 1, 2, 4, 5, and 6) and cross-entropy for the multi-class classification task (Dataset 3). Additionally, mean-squared error was used for the consistency loss. The student model was optimized using the stochastic gradient descent (SGD) optimizer with an initial learning rate of 0.3, and a batch size of 200, distributed across four Nvidia V100 GPUs with a memory of 16 GB per-card, for 200 rounds of pretraining (i.e., iterating through all datasets 200 times). A stop-gradient operator was applied to the teacher model, and it was updated using epoch-wise EMA of the student parameters at the end of each task, with an initial momentum of 0.9. The image augmentation function τ(⋅) included random cropping, rotation, and adjustments to brightness, contrast, and gamma distribution. Ark+5 and Ark+6 were pretrained for approximately 300 and 600 hours, respectively.

To demonstrate that Ark+ is architecture-independent and scalable to higher resolutions, two additional Ark+6 models were pretrained using different backbones: the ConvNext Base with an input resolution of 224×224 and the Swin Transformer Large with an input resolution of 768×768. Pretraining the ConvNext version of Ark+6 follows the same configuration as the Swin Base version, using initialization weights from the official release. For the Swin Large version, the models were based on the configuration of the official Swin Large 384×384 version and scaled up the input resolution to 768×768. This model was pretrained with a batch size of 50 using four Nvidia A100 GPUs, each with 80 GB of memory, for 50 rounds (approximately 700 hours). The remainder of the configurations were constant.

### 3.2. Ablating ARK⁺

To evaluate the contributions of three key components in Ark+ and examine the influence of two additional factors on its overall performance, a comprehensive set of ablation studies was conducted. In each experiment, one component or training condition was removed or modified from Ark+ while keeping all others unchanged, allowing the isolation and quantification of each individual impact on model effectiveness. These controlled experiments provide insights into the design rationale behind Ark+ and validate the importance of each element in achieving optimal performance. Specifically, the following ablation experiments were designed:
Role of the teacher model: Remove the teacher model and the associated consistency loss.
Benefits of multi-task heads: Replace multi-task heads with a single-task head using a predefined, manually assembled label list (FIG. 23).
Effect of cyclic vs. concurrent pretraining: Substitute the sequential cyclic pretraining strategy with a concurrent multi-source pretraining approach, in which mini batches are constructed by equally or randomly sampling from all datasets and losses are calculated based on the respective dataset identifications and labels.
Order of dataset visitation: Compare sequential, inverse, and random orders of dataset visitation during cyclic pretraining.
Scale and diversity of pretraining data: Evaluate Ark+ models pretrained on one, two, and five datasets to assess the impact of data scale and diversity.

Each ablated variant was pretrained under the same experimental setup as described in Section 3.1, using the training sets from Datasets 1-5, and compared with Ark+5.

3.3 Pretraining with Data Distributed Across Multiple Clients

The Ark+ framework is designed to be robust and scalable, also supporting training with data distributed across multiple clients while ensuring that each client maintains its proprietary data. To validate the effectiveness and feasibility of this distributed training approach, a distributed training environment was simulated with multiple clients. Each client was responsible for training a local Ark+ model with its proprietary data and sharing the student model weights with the central server for model aggregation. Three scenarios were tested:
5-client distribution: Each client possesses one dataset.
3-client distribution: Client #1 possesses 1.CXPT, client #2 possesses 2.NIHC and 5.SZTB, and client #3 possesses 3.RSNA and 4.VINC.
3+1-client distribution: Initially distributed across three clients, then extended to a fourth client which possesses 6.MMIC.

In each scenario, clients trained their local student models independently using their respective data and tasks, updating their local teacher models via epoch-wise EMA, following the same configuration of the Swin-Base version as in Section 3.1. The central server aggregated the student model weights from all clients through weight averaging and redistributed the updated global master model back to the clients. For the first two scenarios, this iterative process continues for 400 iterations (number of communication rounds). In the third scenario, training begins with three clients for 100 iterations, then extends to four clients, continuing for an additional 100 iterations.

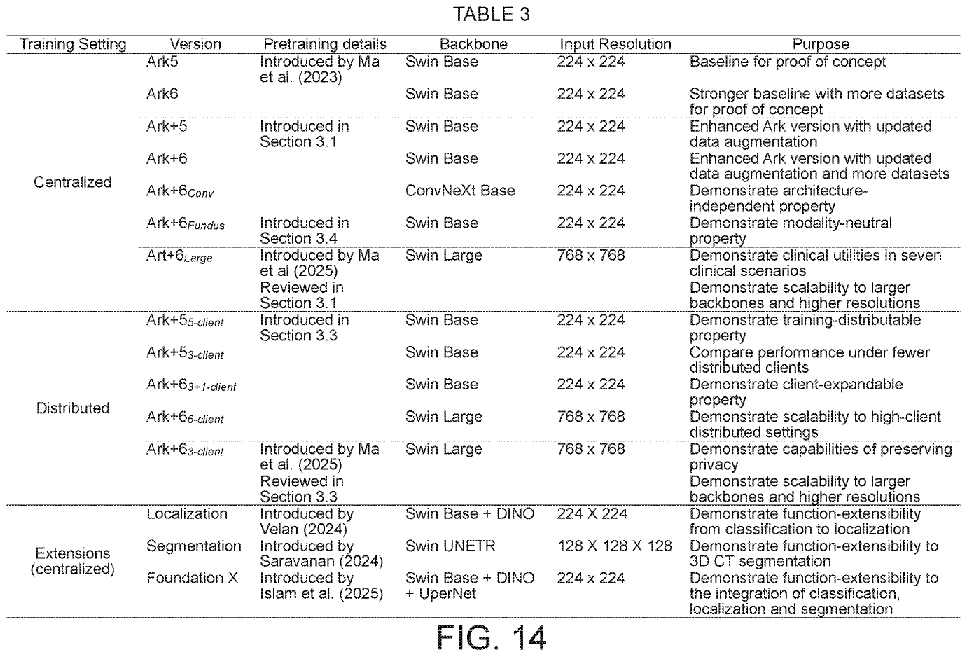

Table 3 presented in FIG. 14 shows how a family of Ark/Ark+ models were pretrained under various settings with different model architectures, datasets, and input resolutions. Each configuration is designed to demonstrate specific properties, including architecture-independent, resolution-scalable, modality-neutral, training-distributable, and client-expandable. Note that Ark+6_{Large} and Ark+6_{3-client} introduced by Ma et al. (2025) for demonstrating clinical utilities in various clinical scenarios were utilized in this disclosure to show scalability to larger backbones and higher resolutions; however, for comprehensive technical evaluations and ablation studies, the standard architecture (Swin Base) and established resolution (224×224) are desired to reduce the GPU hours required by pretraining in many runs. To further demonstrate the scalability of distributed Ark+ to larger backbones, Ark+6_{Large} was used and evaluated under two additional distributed configurations (FIG. 14).
6-client distribution: Each client holds one dataset.
3-client distribution: Client #1 holds 6.MMIC, Client #2 holds 1.CXPT and 3.RSNA, and Client #3 holds 2.NIHC, 4.VINC, and 5.SZTB.

Each setting was trained for 50 communication rounds. For comparison, an isolated (local) training setup was also included, where Ark+ is trained centrally on all datasets without inter-client communication, to assess the benefits of collaborative distributed training.

### 3.4. Pretraining Ark+ on Fundus Photography

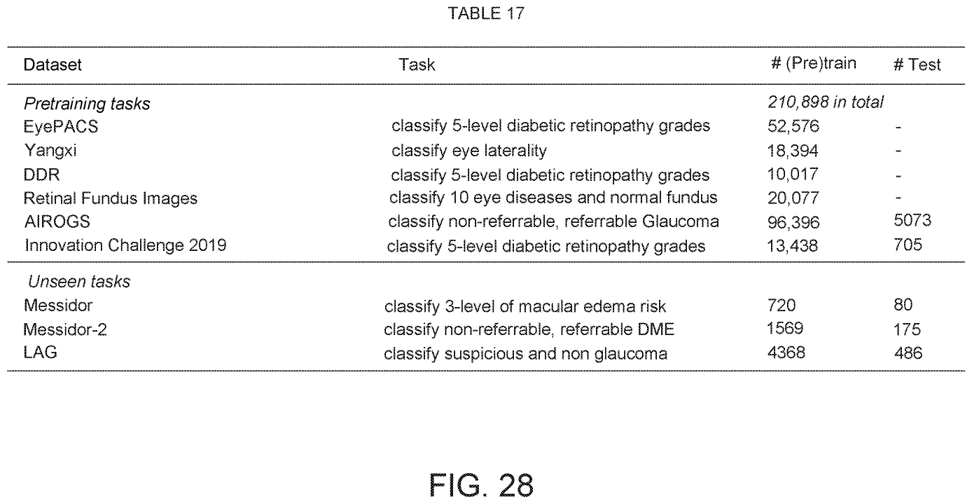

As a pretraining framework for foundation models, Ark+ is not limited to chest radiography. To demonstrate the versatility and adaptability of Ark+, its application was extended to another imaging modality-fundus photography. Fundus photography is a crucial diagnostic tool in ophthalmology, used to capture detailed images of the retina, optic disc, and other structures at the back of the eye. These images play a critical role in diagnosing conditions such as macular degeneration, retinal neoplasms, choroid disturbances, diabetic retinopathy, glaucoma, multiple sclerosis, and other central nervous system anomalies. A specialized Ark+6_{Fundus} model tailored for this domain was developed using six public fundus photography datasets (detailed in Table 17 presented in FIG. 28): AIROGS, EyePACS Kaggle, Retinal Fundus Images, Innovation Challenge 2019, OIA-DDR, and Yangxi. The model was pretrained with a batch size of 256 on a single NVIDIA A100 GPU for 12 rounds. All other training configurations were kept consistent with those described in Section 3.1.

In summary, a family of Ark and Ark+ models and their extensions as listed in FIG. 14 were pretrained, where each member is annotated with its specific purpose, highlighting its key properties such as architecture-independent, resolution-scalable, modality-neutral, training-distributable, and client-expandable.

### 4. BENCHMARKING ARK+

### 4.1. Fine-Tuning Ark+ Models on Diverse Imaging Tasks

The pretrained teacher model was adapted to various imaging tasks (listed in Table 2, FIG. 13), including classification, segmentation, and localization through transfer learning or fine-tuning.

### 4.1.1. Classification Tasks

Ark+ models were evaluated via transfer learning and compared with SOTA fully-supervised and self-supervised models. For fair comparisons, the SOTA was followed and the same image augmentation strategy applied for all methods. All downstream models share the same Swin Base backbone, where the encoder was initialized using the pretrained weights and a task-specific classification head was re-initialized based on the number of classes for the target task. All layers were fine-tuned in the downstream models under the same experimental setup. The performance of binary/multi-label classification was measured by AUC (area under the receiver operating characteristic curve), multi-class classification by accuracy. Additionally, the performance for the long-tailed classification tasks by mAP (mean average precision) and mF1 (mean F1 score) were measured to assess overall accuracy and robustness across imbalanced classes. 10 trials were performed, reporting the mean and standard deviation of the performance metrics, and assessing statistical significance using the independent two-sample t-test. Note that Google CXR-FM could not be included for comparison as it is not publicly released for fine-tuning.

Additionally, for fundus photography, Ark+6_{Fundus} was evaluated under the fine-tuning configuration and its performance compared against the SOTA scores reported by the AIROGS and Innovation Challenge 2019, as well as three unseen tasks using LAG, MESSIDOR and MESSIDOR-2.

### 4.1.2. Segmentation Tasks

The segmentation network is built upon UperNet, which consists of a backbone network, a feature pyramid network, and a decoder network. The backbone network is implemented with Swin Base and initialized with the pretrained weights from the Ark+ and the aforementioned SOTA models. The remaining networks are randomly initialized. All layers in the segmentation models were fine-tuned under the same experimental setup. The image augmentation strategy includes shifting, scaling, and rotating images (with a rotation limit of 10 degrees), as well as randomly adjusting brightness and contrast. The segmentation performance was measured using the Dice coefficient, which evaluates the similarity between the predicted segmentation mask and the ground truth segmentation mask.

### 4.1.3. Localization Tasks

The localization network was built upon DINO (DETR with Improved deNoising anchOr boxes), which consists of a transformer encoder and a decoder. The disclosed embodiments replaced the encoder network (backbone) with Swin Base and initialized it with the pretrained weights from the Ark+ and the SOTA models. The remaining networks (DINO localizer) were randomly initialized. All layers in the localization models were fine-tuned under the same setup. During fine-tuning, multi-scale image augmentation was employed, where input images are provided at different resolutions within a specified range, along with random crops and 50% random flips. Localization performance was measured using the Free-response Receiver Operating Characteristic (FROC) curve, which describes the rate of true detections of localized lesions against the false positive rate on a per-image basis, and the mean Average Precision calculated at 50% Intersection over Union (mAP50). Additionally, a new SOTA self-supervised model, PEAC, was included, which is pretrained using CXRs and a higher input resolution, for comparison, to confirm the hypothesis that the supervised pretrained models generate better representations than the self-supervised models for the disease localization task. To gain better insights into the localization performance of different pretrained models, their Grad-CAM outputs were visualized using a SOTA implementation for CXR.

### 4.2. Generating Embedding for Linear Probing

The pretrained Ark+ models can be used to extract features or generate embeddings (information-rich numerical vectors) for various chest radiographic tasks, similar to Google CXR-FM. CXR-FM is a proprietary foundation model pretrained on 821,544 labeled and mostly private CXRs using supervised contrastive learning. As the CXR-FM model is not publicly released and cannot be fine-tuned, its available API was used to generate embeddings for all images in the target tasks. To ensure fairness, embeddings were also generated from Ark+'s projector, which has a dimension of 1×1376, the same as CXR-FM. Embeddings were pre-generated from Ark+5, Ark+6, and CXR-FM, and a simple linear classifier trained for each target task to evaluate the quality of their embeddings.

### 4.3 Analyzing Sex-Related Bias

To assess the model's ability to tolerate sex-related bias, under the linear-probing configuration, sex-exclusive training sets of 1.CXPT and 2.NIHC were used by following the setup in Larrazabal et al. “Gender imbalance in medical imaging datasets produces biased classifiers for computer-aided diagnosis,” Proc. Natl. Acad. Sci. 117 (23), 12592-12594. Their train/test splits were followed to ensure a balanced number of cases per class in the 20 male-only and 20 female-only folds, where the labels “No Finding” and “Support Device” are excluded for 1.CXPT. For each dataset, 40 linear classifiers with the male-only and female-only splits were trained using embeddings from each model to evaluate sex biases. These classifiers were then evaluated on the corresponding male/female-only test splits and the average performance reported over the 20 folds. A biased result is identified by a statistically significant decline in performance when training and test data are of the opposite sex, compared to when they are of the same sex.

### 5. RESULTS

### 5.1. Ark+ Outperforms SOTA Fully/Self-Supervised Methods on Various Tasks for Thoracic Disease Classification

To demonstrate the performance improvements achieved through Ark+ pretraining, an internal evaluation was conducted using the hold-out test data from the five pretraining datasets via fine-tuning. Ark+ models were compared with (SOTA) fully supervised and self-supervised models pretrained on ImageNet. Additionally, a comparison with a SOTA domain-adapted model, MIM-CXR, which was first pretrained on ImageNet and then on a large-scale domain-specific dataset comprising 926,028 CXRs from 13 different sources was included. For reference, the performance of downstream models trained from scratch (with randomly initialized model weights) was also reported to establish a lower bound for performance.

As shown in Table 4, presented in FIG. 15, Ark+ models consistently outperform the SOTA fully/self-supervised ImageNet pretrained models on all target tasks. Ark+ models outperform SOTA ImageNet pretrained models and the self-supervised domain-adapted model that utilizes even more training data, highlighting the importance of accruing and reusing knowledge in expert labels from diverse datasets for classification tasks. For ease of comparison, the mean AUC score was evaluated for multi-label classification tasks (i.e., 1.CXPT, 2.NIHC, and 4.VINC), the AUC score for the binary classification task (i.e., 5.SZTB), and the accuracy for the multi-class classification task (i.e., 3.RSNA). The mean and standard deviation (mean±s.d.) across 10 trials are reported in the table. With the best highlighted in bold and the second best underlined, a statistical analysis is conducted between the best vs. others, where numbers with “ns” indicate no statistically significant difference at level p=0.05. These results highlight the benefit of leveraging additional domain-relevant data in pretraining to reduce the domain gap and further improve model performance on target tasks. Furthermore, compared with the self-supervised domain-adapted model that utilizes 926K CXRs for pretraining, Ark+5 achieves better performance on Datasets 1, 3-5 with only 335K CXRs, and Ark+6 yields significantly superior performance on all five tasks with 704K CXRs. These results demonstrate the superiority of Ark+, stemming from the ability to accrue and reuse knowledge retained in heterogeneous expert annotations from multiple datasets, emphasizing the importance of learning from expert labels. Moreover, it was observed that Ark and Ark+ models leveraging six datasets consistently outperformed those using five datasets, indicating the importance of incorporating more data and annotations from diverse datasets during pretraining. Finally, Ark+ models surpass their previous versions across all tasks, demonstrating the effectiveness of the updated data augmentation scheme that feeds the teacher model with the resized original image instead of using random cropping. These performance gains support the hypothesis that ensuring the teacher provides a consistent and steady supervisory signal for computing the consistency loss can accelerate training and enhance overall performance.

To further assess Ark+'s adaptability, an external evaluation was conducted on an “unseen” task that involves distinguishing COVID-19, non-COVID pneumonia, and normal cases using the COVIDx dataset. During pretraining, Ark+ never encountered COVID-19 or “saw” any images from this dataset. In contrast, MIM-CXR used these images in its self-supervised pretraining, giving it an advantage. For reference, a comparison with the fully supervised ImageNet pretrained model was also included. To evaluate the model's label efficiency, the training data was reduced to 10% and 1% of the full sample size. FIG. 2 shows that Ark+6 significantly outperforms both the supervised baseline and MIM-CXR when using the full dataset and reduced data for fine-tuning, underscoring the superior adaptability of Ark+6 even though it has never seen COVID-19 cases during its pretraining. FIG. 2 details how Ark+6 significantly outperforms both the supervised ImageNet model and MIM-CXR, at level p=0.05, when using the full dataset and reduced data for fine-tuning, demonstrating the superior adaptability of Ark+6 despite not seeing COVID-19 cases during its pretraining. This suggests that learning from diverse expert labels provides better discriminative abilities to the Ark+ model, enabling it to achieve higher performance when adapting to tasks involving novel diseases.

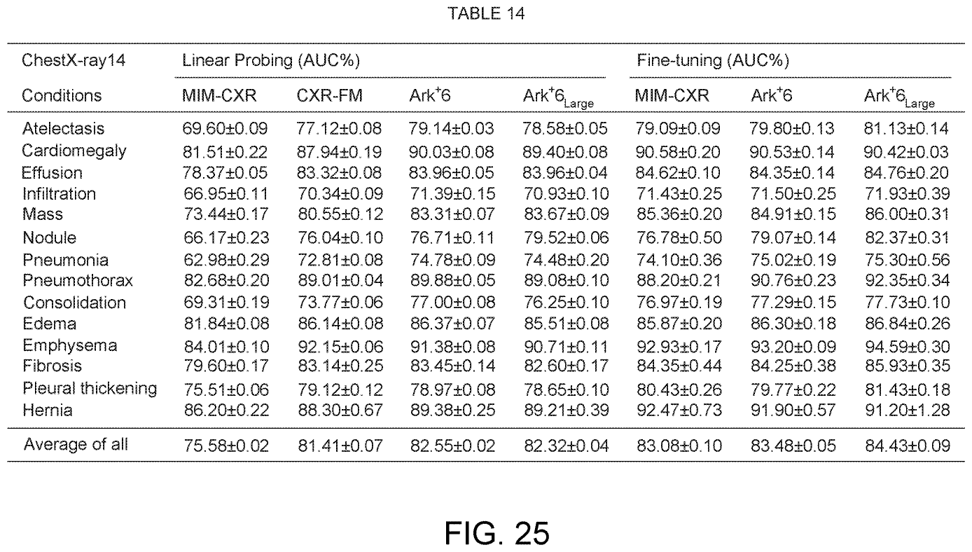

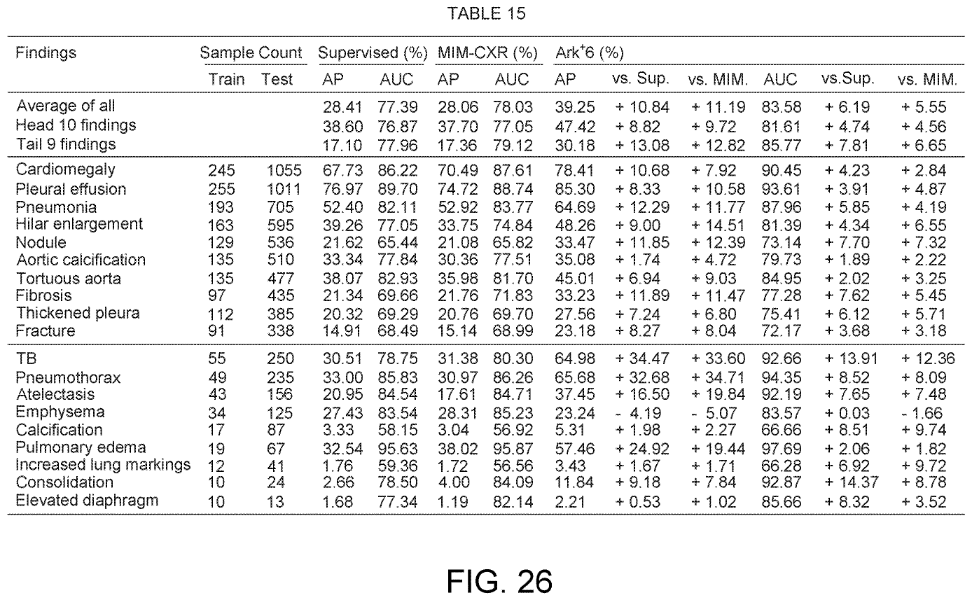

For a more comprehensive evaluation, the robustness and generalizability of Ark⁺ models were examined in long-tailed scenarios—a common issue in chest radiographic diagnosis where the distribution of clinical findings is skewed toward a few common abnormalities, and rare conditions are less frequently encountered. As evident in Table 5, presented in FIG. 16, Ark⁺ models exhibit remarkable performance for the two long-tailed tasks. Specifically, Ark⁺6 significantly surpasses both the supervised ImageNet model and MIM-CXR on 9.CHDR for diagnosing 19 thoracic diseases with long-tailed distributions, achieving the highest mean AUC of 83.58±0.29%, mean AP of 39.25±0.41%, and mean F1 score of 34.64±0.46%, highlighting the superior diagnostic capability of Ark⁺6 in identifying both common and rare thoracic conditions in a skewed dataset. FIG. 16 demonstrates Ark+'s more robust performance for diagnostic tasks involving long-tailed distributions, significantly outperforming both the supervised ImageNet model and MIM-CXR on the unseen 9.CHDR dataset for diagnosing 19 long-tailed thoracic diseases. 10.CXLT is a long-tailed classification challenge based on 6.MMIC, but it includes 12 newly added disease findings extracted from associated radiology reports. Ark+5 was used for this task, as it is not pretrained with 6.MMIC, whereas MIM-CXR has seen these images, placing Ark+5 at a disadvantage. Nevertheless, Ark+5 outperforms the ImageNet model and rivals MIM-CXR. In the table, the best results are highlighted in bold and the second-best are underlined. Numbers with “ns” indicate no statistically significant difference from the best result at the p=0.05 level. A detailed comparison of classification performance for individual findings, along with their corresponding sample counts, is provided in Table 15, presented in FIG. 26 to support disease-specific insights. Similarly, in the 10.CXLT task, Ark⁺5, despite the lack of pretraining with 6.MMIC data, shows competitive performance against MIM-CXR, which had prior exposure to the dataset. Ark⁺5 achieves a slightly lower mean AUC and mean F1 score compared to MIM-CXR, but outperforms it in mean AP, underscoring the robustness and adaptability of Ark⁺ models for diagnostic tasks involving long-tailed distributions, ensuring reliable and accurate detection of both common and rare thoracic diseases.

### 5.2. Ark+ Provides Generalizable Representations for Segmentation and Localization Tasks

To evaluate the generalizability of Ark+'s representations, the Ark+ models were transferred to six segmentation tasks involving lungs, heart, clavicles, ribs and thoracic diseases, and their performance compared with three SOTA fully/self-supervised models. As seen in Table 6 presented in FIG. 17, Ark+ models achieve significantly better performance than the SOTA models, demonstrating that Ark+ learned generalizable representations for delineating organs, bones and various thoracic diseases visible at CXR. FIG. 17 shows the results when Ark+ models were transferred to six segmentation tasks involving lungs, heart, clavicles, ribs, and thoracic diseases. The superior performance of Ark+, compared with the SOTA ImageNet pretrained models and the self-supervised domain-adapted model, demonstrates Ark+ provides generalizable representations for segmentation tasks. The Dice score is adopted to evaluate the performance. The mean and standard deviation (mean±s.d.) across 10 trials are reported in the table. With the best highlighted in bold and the second best underlined, a statistical analysis is conducted between the best vs. others, where numbers with “ns” indicate no statistically significant difference at level p=0.05. This superior performance is achieved by pretraining using large-scale CXRs and various disease labels from diverse datasets. Certain thoracic abnormalities can be diagnosed by examining the edges of the lungs, heart, clavicles, or ribs at CXR. For instance, a pneumothorax can be detected by observing a visible “visceral pleural line” along part or all the length of the lateral chest wall. Cardiomegaly can be diagnosed when the heart appears enlarged, with maximum diameter of the heart exceeding a pre-defined cardiothoracic ratio. Fractures can be identified when the edges of the clavicles or ribs appear abnormally displaced, or the bone cortex appears offset. Therefore, leveraging diagnostic information from disease labels during pretraining enables Ark/Ark+ models to better capture the nuanced and varied pathological patterns, strengthening the models' ability to represent anatomically specific features that reflect abnormal conditions in various organs or bones. By contrast, the MIM-CXR model was pretrained using a self-supervised masked image modeling (MIM) proxy task, which may rely on visual clues to reconstruct the masked patches that are not necessarily related to pathological conditions, leading to lower performance despite training on more images.

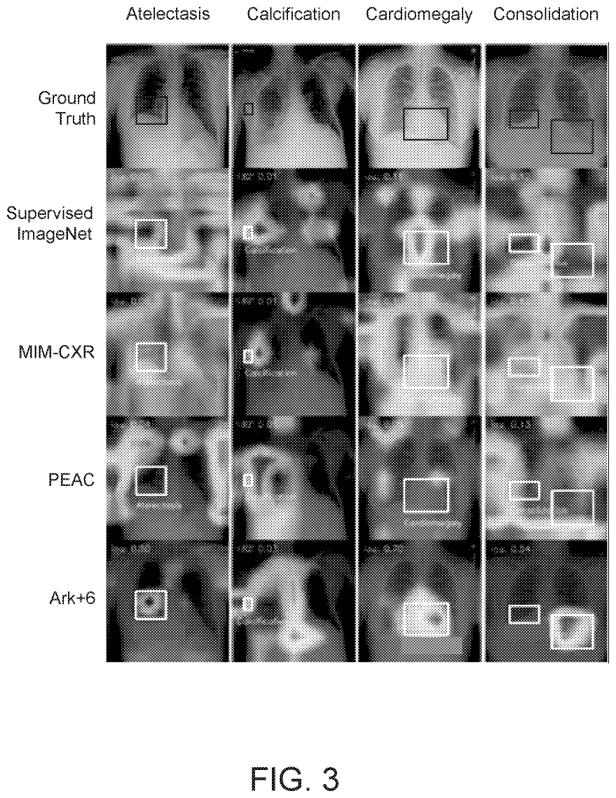

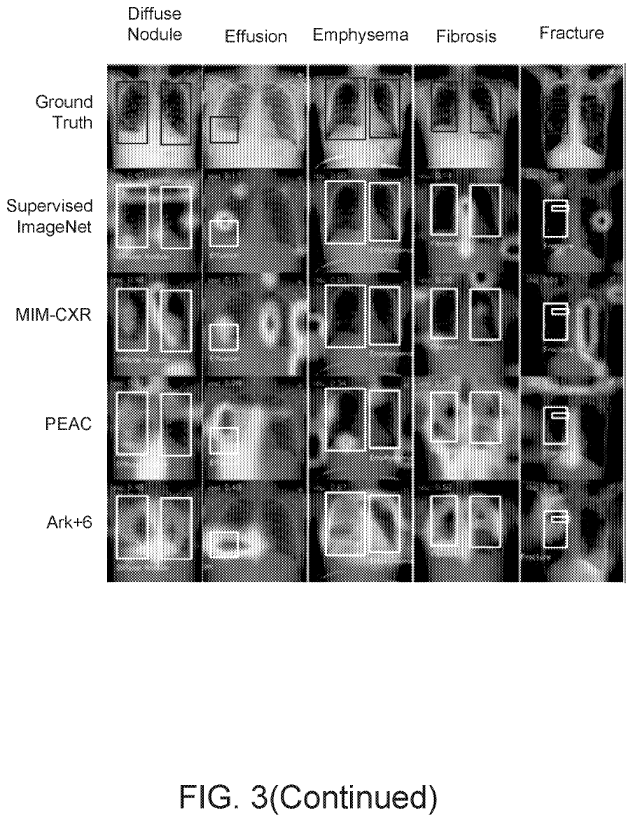

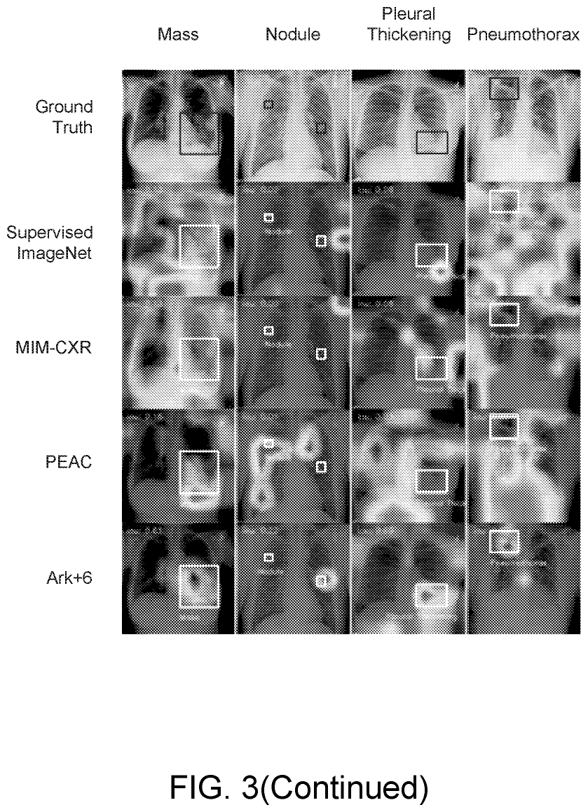

For a more comprehensive evaluation, Ark+6 was transferred to a disease localization task using 14.XDET, which provides bounding box annotations to localize 13 different types of lesions in CXRs. As shown in FIGS. 4A and 4B, Ark+6 exhibits superior performance for localizing 13 different types of lesions in 14.XDET, compared with the supervised ImageNet model and two self-supervised CXR models. FIG. 1A a FROC plot, demonstrates that Ark+6 outperforms the SOTA fully/self-supervised models with higher sensitivity (true localizations) with false positive rates as low as 25 false positives per 100 images, as detailed in Table 16 presented in FIG. 27. FIG. 1B demonstrates that Ark+6 achieves the highest mAP50 score, surpassing other models in mAP50, indicating its superior accuracy in detecting and localizing lesions with a bounding box overlap of at least 50% with the ground truth. Further indicating the localizer fine-tuned from Ark+6 is more accurate in detecting and localizing lesions with a bounding box overlap of at least 50% with the ground truth. These results highlight Ark+6's exceptional ability to provide precise and reliable lesion localization when transferred to the localization task, highlighting that Ark+ provides more generalizable representations. Additionally, it is observed that the supervised models surpass the self-supervised models by a significant margin. To further validate this observation, another SOTA self-supervised model, PEAC, pretrained using CXRs, is introduced for comparison. This finding further confirms that self-supervised models may focus on information relevant to proxy tasks, which may not directly relate to pathological conditions. To gain better insights into the localization performance of different pretrained models, their Grad-CAM outputs were visualized using the test images from 14.XDET. FIG. 3 presents visualization of Grad-CAM heatmaps of the pretrained models which demonstrates that Ark+6 captures the diseased regions more accurately than the other models. The Intersection over Union (IoU), calculated by comparing the bounding box annotation masks with the Grad-CAM maps, shows that Ark+6 provides superior weakly-supervised disease localization.

5.3. Ark+ Offers Embedding with Superior Quality Over Google CXR-FM

To highlight the benefits of learning from detailed diagnostic disease labels, the Ark+ models were compared with Google CXR-FM. CXR-FM was trained on a large dataset of 821,544 CXRs from three different sources, but with coarsened labels (i.e., “normal” vs. “abnormal”). By contrast, Ark+ models were trained with fewer data, but leveraged the granular, expert-annotated labels available in the original datasets. Additionally, Ark+ employs a substantially smaller backbone (88 M parameters) compared with CXR-FM, which uses EfficientNet-L2 (480 M parameters). To evaluate the quality of the learned representations, linear probing was conducted by training a simple linear classifier for each target task. All models were evaluated on six target tasks, including one held-out dataset (7.SIIM) that was unseen during Ark+ pretraining. Performance was further assessed in low-data regimes by conducting the same evaluation on 7.SIIM using partial training sets and few-shot samples, in order to demonstrate the strength of the learned embeddings.

In FIGS. 5A and 5B, Ark+5 and Ark+6 are compared with Google CXR-FM via linear probing on six target tasks, demonstrating Ark+'s superior performance and better embedding quality. As shown in FIGS. 5A and 5B, Ark+6 significantly outperforms CXR-FM across all six tasks. Ark+5 also surpasses CXR-FM on 1.CXPT, 2.NIHC and 7.SIIM, and performs comparably on the remaining tasks. As shown in FIG. 6, Ark+5 and Ark+6 are compared with Google CXR-FM on the pneumothorax classification task using linear probing with reduced training data or even few-shot samples. Remarkably, Ark+6, using just 5% of the data, surpasses CXR-FM's performance achieved with 100% of the training samples, demonstrating that using Ark+6 as the foundation model can reduce the annotation cost by 95% for this target task. Additionally, Ark+6 achieves an average AUC of nearly 90% with only 20 samples, highlighting its capability for few-shot learning and exceptional performance in terms of label efficiency. Moreover, FIG. 6 demonstrates that both Ark+5 and Ark+6 consistently outperform CXR-FM in low-data settings, highlighting the superiority of Ark+'s embeddings that carry richer information that can be utilized more efficiently. Specifically, with only 5% of the training data, Ark+6 achieves an AUC of 93.88±0.17%, exceeding CXR-FM's performance achieved using the full dataset. Furthermore, Ark+6 and Ark+5 reach over 90% AUC with only 20 and 30 samples, respectively. These findings demonstrate that Ark+ models produce higher-quality representations despite using fewer pretraining data and a smaller backbone. They also confirm the advantage of learning from fine-grained diagnostic labels over coarsened labels, such as those used by CXR-FM.

### 5.4. Ark+ Exhibits Robustness for Sex-Related Bias

Population-imbalanced data is a common issue in medical datasets and often leads to the development of biased models. These models tend to underperform in underrepresented populations, such as minorities, compromising diagnostic accuracy and raising ethical concerns about equity and inclusivity in healthcare. To evaluate model robustness under such bias, the setup in Larrazabal et al. (2020) was followed and experiments conducted using sex-exclusive training sets from 1.CXPT and 2.NIHC in a linear probing configuration.

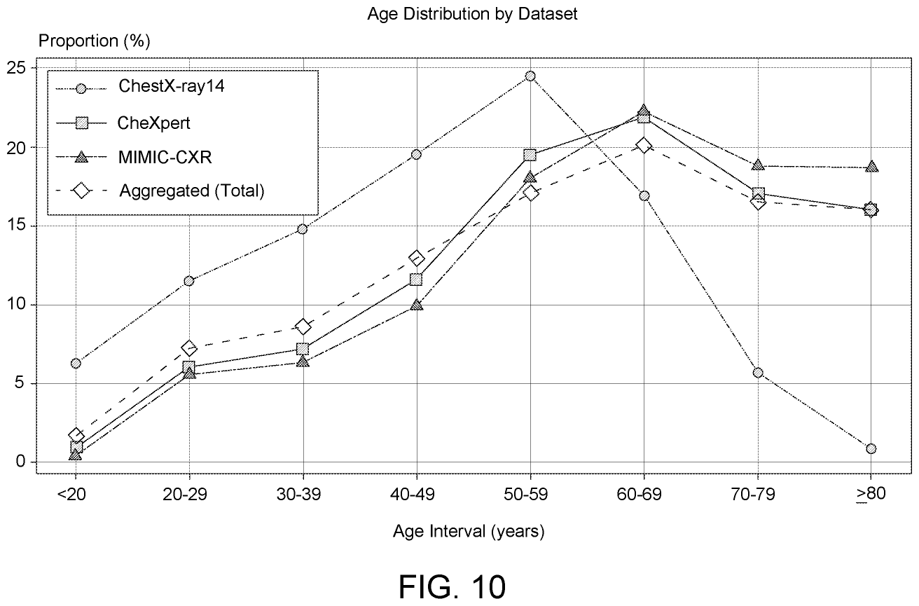

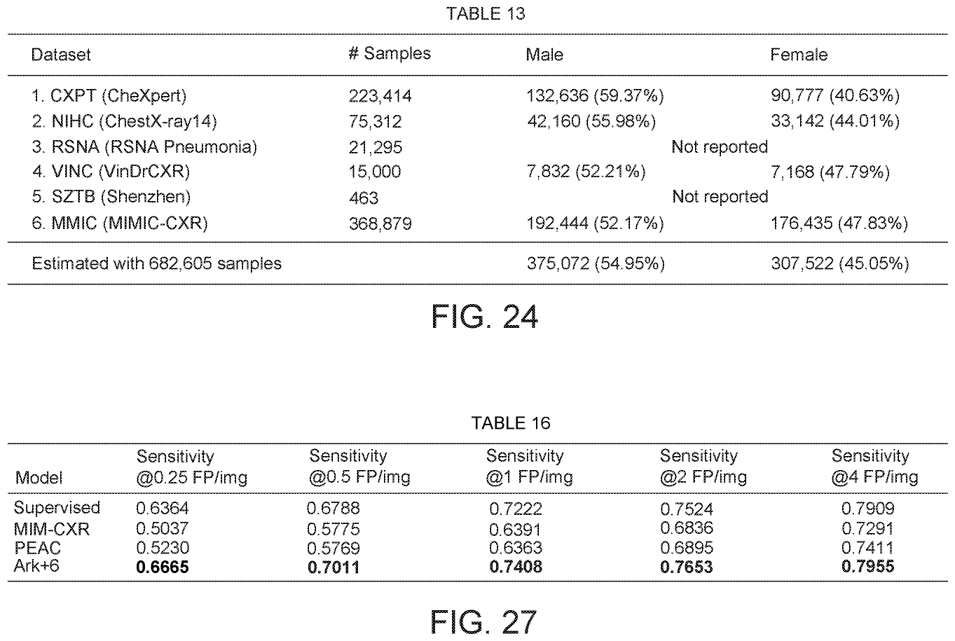

FIGS. 7A and 7B, show that Ark+6 demonstrates greater resilience to sex-imbalanced data, from 1.CXPT (FIG. 7A) and 2.NIHC (FIG. 7B) producing more unbiased results as indicated by box pairs with “n.s.” (no significance) notation. Sex bias is characterized by a significant drop in performance when training and test data are of the opposite sex, compared to when they are of the same sex. Each circle indicates a lung disease with sex bias by CXR-FM, as it performs differently between training on male and female data, while Ark+ exhibits a more robust performance, showing no significant difference in sex-exclusive data. As shown in FIGS. 7A and 7B, bias was assessed by measuring the performance gap between linear classifiers trained on male-only vs. female-only data. For instance, the upper part of FIG. 7A illustrates the scenario where models are tested on female-only data: classifiers trained on male-only data generally perform worse than those trained on female data, revealing sex-related biases stemming from data imbalance. Ideally, an unbiased model would show no significant performance difference between male-only and female-only training, as indicated by “n.s.” in the figure. In FIG. 7A, of the 12 diseases tested, classifiers using CXR-FM embeddings showed unbiased performance (i.e., no significant difference) for only 5 diseases when tested on female data and 3 when tested on male data; by contrast, those using Ark+6's embeddings yielded unbiased performance, with no significant differences for 8 diseases when tested on female patients and 6 diseases when tested on male patients. Similarly, in FIG. 7B, among the 28 conditions evaluated, Ark+6 showed 17 unbiased results, whereas CXR-FM showed only 12. These findings suggest that Ark+ embeddings offer greater robustness to severe sex-based data imbalance, thereby promoting more equitable computer-aided diagnosis. Note that the patient sex distribution in the pretraining datasets of Ark+ and CXR-FM is approximately 55% male/45% female and 60% male/40% female, respectively. See Table 13 in FIG. 24, which summarizes the patient sex distribution across the pretraining datasets, providing context for analysis of sex-related bias. FIG. 10 further illustrates how data aggregation yields a more balanced age composition compared with individual datasets. Together, these materials enhance transparency regarding data composition and support the interpretation of Ark+'s robustness under long-tailed distributions and population imbalances. FIG. 24, Table 13, represents distribution of patient sex across the pretraining datasets used in Ark+. This breakdown provides insight into the demographic balance of the pretraining data and informs analysis of potential sex-related bias in Ark+. The male-to-female ratio is estimated based on metadata available from four of the constituent datasets. The aggregation of multiple data sources in Ark+ contributes to a more balanced sex distribution. This relatively improved balance may partially explain the enhanced robustness to sex-related bias observed in the evaluation results.

### 5.5. Ark+ is Training-Distributable and Client-Expandable

Ark+ supports training with data distributed across multiple clients, each retaining proprietary datasets. In this setup, only the student model weights are shared with a central server for aggregation via weight averaging and then redistributed to all clients. This strategy enables collaborative learning while preserving data privacy. To demonstrate the feasibility and effectiveness of distributed training, two scenarios were simulated: (1) a 5-client setting where each client holds one dataset, and (2) a 3-client setting where datasets are grouped across three clients. Additionally, to illustrate client expandability, a new client was introduced with the 6.MMIC dataset midway through the 3-client training run (i.e., distributed: 3+1 clients). Each client maintains its own teacher model and multi-task heads via EMA. For evaluation, the local teacher model was used to test each task through its corresponding multi-task head, without any further fine-tuning. For comparison, the fine-tuning performances of Ark+5 and Ark+6 pretrained with the centralized approach was reported as the upper bound, and that of the ImageNet-pretrained model as a lower bound.

As shown in FIG. 18, Table 7, models trained in the distributed setting achieved performance comparable to their centralized counterparts, with less than a 2% performance drop. FIG. 19, Table 8 illustrates that training Ark+ with data distributed across multiple clients maintains high performance across all tasks, underscoring the effectiveness and practicality of the distributed approach. Compared with the supervised ImageNet-pretrained models fine-tuned on individual tasks, the distributed Ark+ models consistently achieve superior results, highlighting the benefits of collaborative model and data sharing in building robust, open foundation models. Task performance is evaluated using predictions from the multi-task heads of each local teacher and the server master model, immediately after training, without additional fine-tuning. In some cases, distributed models even outperformed centralized ones, for instance, Ark+5 trained across five clients achieved 75.71% accuracy on 3.RSNA. These results align with observations in federated learning, where centralized training typically outperforms distributed training, yet distributed training remains an effective and viable alternative. Furthermore, compared with supervised models fine-tuned from ImageNet, the distributed Ark+ models demonstrated superior performance across all tasks. For example, the distributed Ark+6 models (3+1 clients) surpassed the supervised baseline by +0.21% on 1.CXPT, +0.48% on 2.NIHC, +5.65% on 5.SZTB, +0.9% on 3.RSNA, +4.01% on 4.VINC, and +0.47% on 6.MMIC, demonstrating the benefit of collaborative training even without data sharing.

To further demonstrate the scalability of Ark+ and performance in different settings, Ark+6_{Large} and Ark+6_{3-client} (in Table 3, FIG. 14) were used and an additional distributed model Ark+6_{6-client} pretrained. As shown in FIG. 19, Table 8, distributed Ark+ achieves strong average AUCs of 87.06% (3-client) and 86.50% (6-client), closely matching the 87.60% of the centralized model. FIG. 19 sets out a performance comparison of distributed Ark+ scaled to the Swin-Large backbone (768×768), evaluated under two distributed settings (6-client and 3-client), alongside centralized and isolated (local) training baselines. Similar to FIG. 18, the results demonstrate that distributed Ark+ maintains high average performance across tasks even with a larger backbone and higher input resolution, highlighting its scalability. Performance improvements over isolated training are especially notable for clients with limited data (e.g., 4.VINC and SZTB), highlighting the collaborative benefits. Meanwhile, slight performance drops for clients with large datasets (e.g., 6.MMIC, 1.CXPT, and 2.NIHC) are likely due to naïve weight averaging during aggregation, which may dilute their contribution. This limitation could be addressed with more adaptive strategies, such as data-size-aware or performance-aware weighted averaging. ↓ and ↑ in the table denote performance degradation and improvement, respectively, of distributed training compared with isolated training.

These results confirm that Ark+ is both training-distributable and client-expandable, making it a practical and scalable solution for building collaborative foundation models while preserving data autonomy.

### 5.6. Ark+ is Architecture-Independent and Resolution Scalable

As a foundation model pretraining framework, Ark+ should be adaptable to diverse model architectures, whether transformer-based or convolutional neural networks (CNN)-based, and scalable to higher input resolutions to better exploit fine-grained image details. To demonstrate these properties, Ark+6 models built on three architectures were evaluated: Swin Transformer Base, ConvNeXt Base (both using an input resolution of 224×224), and Swin Transformer Large with a higher resolution of 768×768.

As shown in FIG. 20, Table 9, Ark+ consistently achieves strong performance across different architectural choices. Ark+ maintains high performance across diverse architectural choices (ConvNeXt, Swin Transformer) and can leverage a larger backbone (Swin Large) and a higher input resolution (768×768) to achieve even better results. This demonstrates that Ark+ is both architecture-independent and scalable to higher resolutions. In the table, the best results are highlighted in bold and the second-best are underlined. Statistical comparisons between the best and remaining results demonstrated significant differences at level p=0.05. The ConvNeXt Base model demonstrates strong performance with 89.28±0.52% on 1.CXPT and 98.78±0.26% on 5.SZTB, although it slightly underperforms compared with the Swin Transformer models. This suggests that transformer-based models, when pretrained with large-scale data, can exhibit stronger performance than CNN-based models, as also corroborated by Hosseinzadeh Taher et al. (2025), “Large-scale benchmarking and boosting transfer learning for medical image analysis,” Med. Image Anal. 102, 103487. Furthermore, the Swin Transformer Large model, with the higher resolution input of 768×768, excels the base version on the 2.NIHC, 3.RSNA, and 4.VINC tasks, achieving top scores of 84.43±0.09%, 76.06±0.20%, and 96.42±0.10%, respectively, and showing competitive performance on other tasks. These results confirm that Ark+ is both architecture-independent and resolution-scalable, capable of effectively leveraging different network architectures and high-resolution inputs to boost performance in various chest radiograph analysis tasks.

### 5.7. Ark+ is Modality-Neutral and Extensible to Fundus Photography

To demonstrate the versatility of Ark+ beyond chest radiography, the framework was extended to fundus photography by pretraining a specialized model, Ark+6_{Fundus}, using six public fundus image datasets (detailed in Table 17, FIG. 28). This model was evaluated through two internal pretraining tasks and three external, previously unseen tasks, comparing its performance with SOTA scores reported in the literature or challenge benchmarks. As shown in FIG. 21, Table 10, Ark+6_{Fundus} surpasses the SOTA scores on the internal tasks by a significant margin and achieves superior or comparable performance on the unseen tasks. Ark+6_{Fundus} surpasses the SOTA scores reported in the literature or by challenged benchmarks on the pretraining tasks by a significant margin, and achieves superior or comparable performance on the unseen tasks, highlighting its extensibility to diverse imaging modalities. The mean and standard deviation (mean±s.d.) across three trials are reported in the table. These findings confirm that Ark+ generalizes effectively to other medical imaging modalities, highlighting its modality-neutral and extensible design.

### 5.8. Studying Ark+ Via Ablations

### 5.8.1. Teacher Model Stabilizes Performance

To evaluate the importance of the teacher model in Ark+, its role is ablated by removing the teacher and associated consistency loss during pretraining. As described in Section 2, the teacher model in Ark+ is updated using an EMA of the student's weights, serving as a stable repository of knowledge accumulated across tasks and epochs. It provides additional supervision to the student model via a consistency loss, helping to preserve historical knowledge and mitigate forgetting in the cyclic pretraining process.

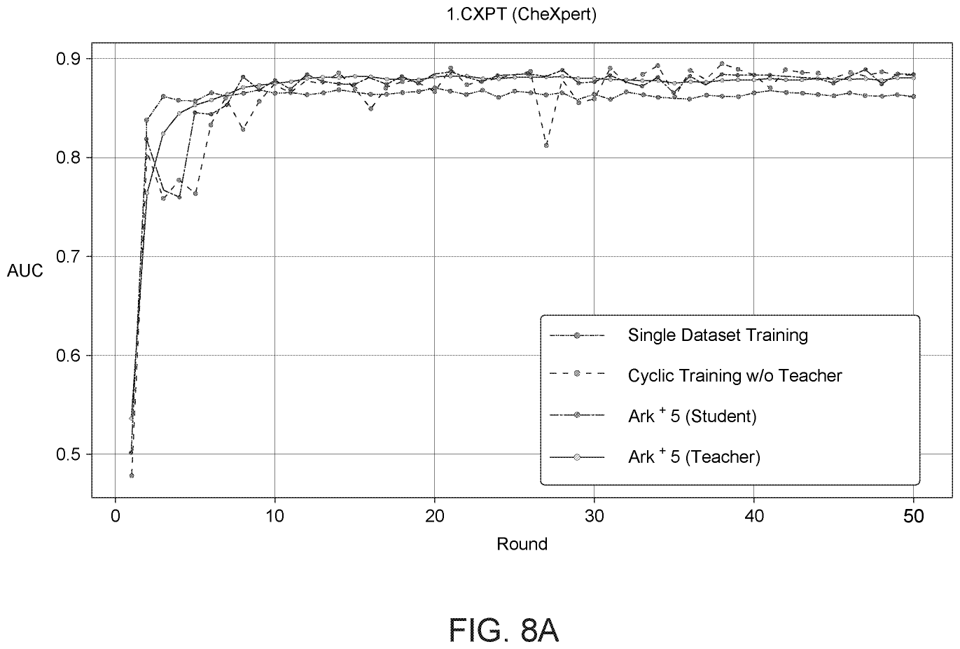

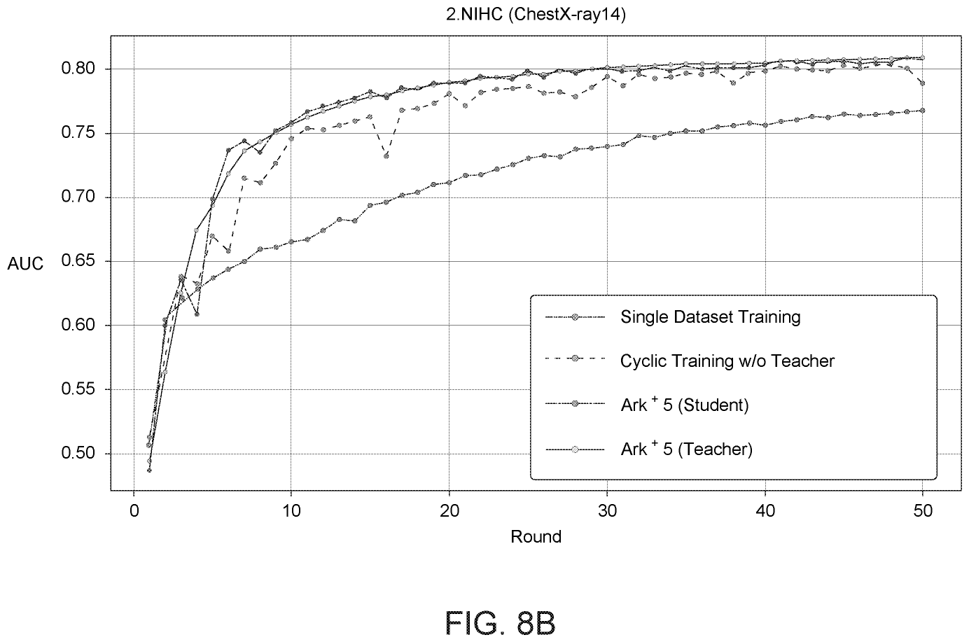

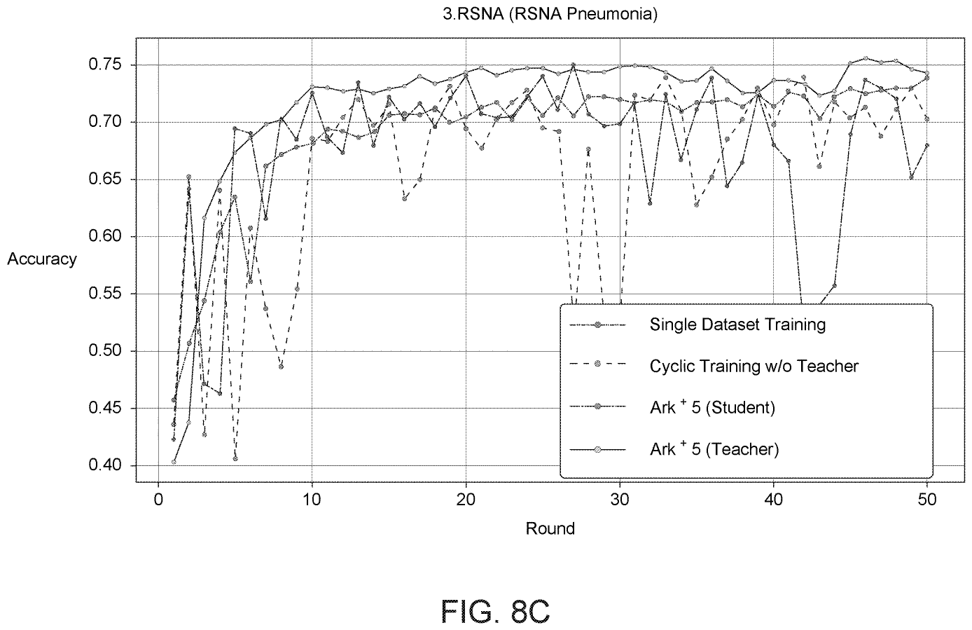

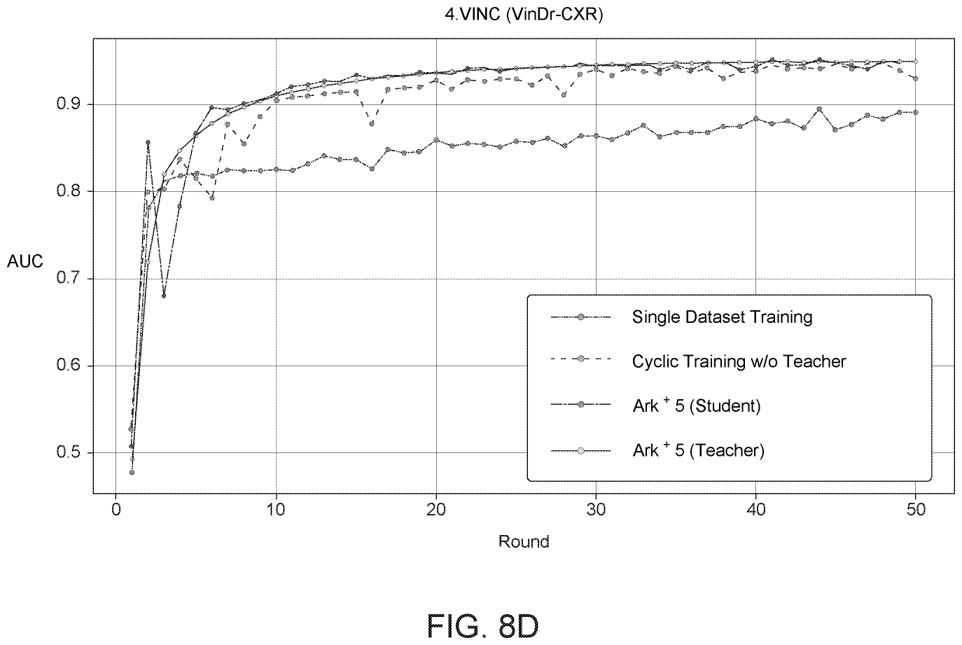

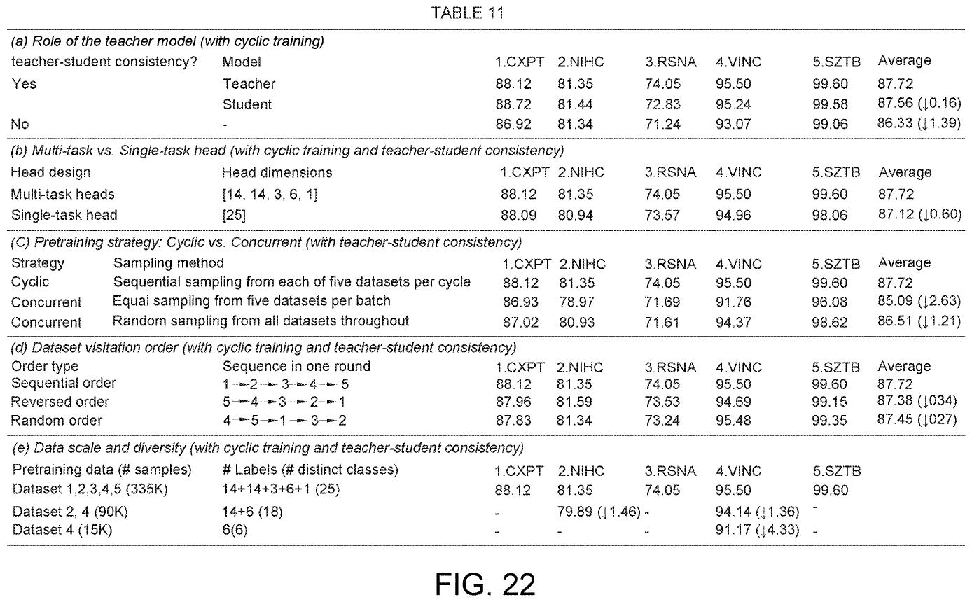

FIG. 22, Table 11 shows ablation Studies evaluating the contribution of three key design components in Ark+ (a-c) and examining the influence of two additional factors (d-e) on its overall performance. The results demonstrate Ark+ benefits from teacher-student consistency framework, multi-task heads, cyclic pretraining, and large-scale diverse data. All results are obtained by directly using the corresponding task heads (with no further tuning) for end-to-end inference on the hold-out test sets of the five datasets. Performance is reported as classification AUC/Accuracy, with the average column reflecting the mean across datasets for each configuration. ↓ indicates the performance drop of each ablated variant compared with Ark+5. Results in FIG. 22, Table 11(a) demonstrate that the teacher model generally outperforms both the student model and the version trained without teacher-student consistency, highlighting the effectiveness of the consistency framework. FIGS. 8A-8E illustrate performance trajectories for the ablated variant without the teacher model and consistency loss (with cyclic training), alongside those for the student model and teacher model of Ark+5 (with cyclic training). The performance on the five tasks was evaluated at the end of each pretraining round. Compared with the ablated variant (, the student model trained with the consistency framework exhibits more stable performance, while the teacher model shows even smoother trajectories, highlighting the stabilizing effect of the teacher-student consistency mechanism in cyclic training. Furthermore, for reference, the performance trajectory of the individual model trained on each single dataset is also shown, highlighting the performance gains thanks to cyclic training that exploits the synergies among multiple datasets (with or without the teacher model and consistency loss). This also reveals that cyclically training one model using multiple dataset without the teacher model and consistency loss may not be as stable as the traditional approach for training one model using one single dataset (e.g., 3.RSNA (RSNA Pneumonia)), in which cyclic training is vanished, further corroborating the importance of the teacher model and consistency loss for cyclic training. Additionally, FIGS. 8A-8E present the performance trajectories over the first 50 pretraining rounds, demonstrating not only the stabilizing effect introduced by the teacher-student framework but also the synergistic effect of cyclic training across multiple datasets compared with training on a single dataset.

### 5.8.2. Multi-Task Heads Offer Multiple Benefits

Conventional approaches typically rely on a single-task head and require manual consolidation of heterogeneous labels from multiple datasets. For instance, one approach involved pretrained models using data from four different sources by merging all labels into a unified list of 18 conditions. By contrast, the multi-task head design in Ark+ provides several key benefits:
1. Minimizing manual effort: Multi-task heads eliminate the need to manually merge and align labels across datasets (see FIG. 23), streamlining the setup process and reducing preprocessing overhead.
2. Maximizing flexibility and scalability: The modular design allows new tasks or datasets to be added seamlessly by introducing new heads, without requiring retraining or modifying the output space of a monolithic head.
3. Simplifying implementation: Task-specific heads avoid the complexity of managing dataset-dependent class indices and label mappings, which are often required in single-head configurations for correct loss computation.

Results in FIG. 22, Table 11(b) also show that Ark+ with multi-task heads consistently outperforms the single-task head, highlighting the performance advantage conferred by the multi-task design.

### 5.8.3. Cyclic Pretraining Outperforms Concurrent Pretraining

Although all datasets are centralized and accessible, a cyclic pretraining strategy was adopted over concurrent (simultaneous) training to achieve better performance across multiple tasks. Concurrent training computes a combined loss from all tasks in each iteration, which can introduce conflicting gradients during backpropagation. These conflicts may weaken the overall learning signal, slow convergence, and lead to suboptimal performance. By contrast, cyclic pretraining updates the model by focusing on one dataset at a time in a round-robin fashion.

This reduces gradient interference between tasks and allows the model to better specialize on each task, resulting in more stable optimization and improved generalization.

FIG. 22, Table 11(c) presents results from replacing Ark+'s cyclic pretraining strategy with concurrent pretraining, using two alternative sampling methods: equal sampling from five datasets per batch and random sampling from all datasets throughout training. Compared with both concurrent strategies, Ark+ consistently achieves superior performance with cyclic pretraining, highlighting its advantage for leveraging heterogeneous datasets.

### 5.8.4. Dataset Visitation Order has Minimal Effect

While cyclic pretraining improves learning by reducing gradient conflicts, whether the order in which datasets are visited during pretraining affects performance was examined. The default ordering used in Ark+ pretraining follows an intuitive strategy: progressing from larger to smaller datasets, akin to a form of implicit transfer learning. To assess the impact of ordering, this sequential strategy was compared with both reverse and randomly shuffled visitation orders. The results in FIG. 22, Table 11(d) show that model's performance remains largely consistent across different orders, suggesting that Ark+ is robust to dataset visitation order and that the benefits of cyclic pretraining stem more from task focus than from a specific dataset sequence.

### 5.8.5. Larger and More Varied Datasets Enhance Learning

Scaling laws in deep learning consistently demonstrate that model performance improves with increasing data quantity and diversity, particularly in foundation model pretraining. To assess how data scale and heterogeneity influence Ark+, Ark+ models were trained and compared using different combinations of datasets: one, two, and five in total. As shown in FIG. 22, Table 11(e), models trained on more datasets consistently outperform those trained on fewer, demonstrating the advantages of both increased data volume and label diversity. Furthermore, as demonstrated in FIG. 15, Table 4, FIG. 17, Table 6, and FIGS. 5A and 5B, Ark+6, which was pretrained with the additional large-scale dataset (i.e., 6.MMIC), achieves superior performance compared with Ark+5. The richer and more varied diagnostic signals provided by diverse datasets allow Ark+ to learn more generalized and transferable representations. This trend is further corroborated by the distributed training results in FIG. 18, Table 7: the introduction of a new client with additional data into the 3-client setting (i.e., distributed: 3+1 clients) led to performance improvements across multiple tasks, including 1.CXPT, 2.NIHC, 3.RSNA, and 4.VINC. These findings reinforce the importance of scaling both the size and diversity of pretraining data to improve performance across a wide range of clinical tasks.

### 6. DISCUSSIONS

### 6.1. Importance of Expert Domain Knowledge for Training Foundation Models

Expert labels are derived from the extensive knowledge and experience of professionals, such as radiologists in medical imaging, who possess deep expertise in their respective domains. These annotations, accumulated through years of clinical practice, ensure high accuracy and reliability, which is crucial for developing models capable of making precise and credible predictions. Additionally, expert-annotated data in practice often includes nuanced diagnostic information that might be overlooked by non-specialists or self-supervised proxy tasks, thereby enhancing the models' ability to detect subtle patterns and anomalies. This is evidenced in Sections 5.1 and 5.2, where Ark+ demonstrates superior performance compared with the supervised ImageNet model (analogous to a non-specialist) and the self-supervised MIM-CXR model, which was pretrained on large-scale CXRs using a masked image modeling objective. Moreover, expert-provided granular diagnostic labels, with a greater number of specific categories, offer significantly more detailed information than coarse labels (e.g., “normal” vs. “abnormal”). This finer level of annotation embeds richer clinical knowledge, allowing the model to capture complex and subtle variations within the data. As a result, models trained with such granular supervision are better equipped to generalize across diverse cases and may even surpass expert-level performance in certain tasks. As demonstrated in Section 5.3, compared with CXR-FM, which is pretrained using coarsened normal/abnormal labels, Ark+ utilizes more granular labels embedded with detailed diagnostic information and expert knowledge, thereby achieving superior performance despite using fewer pretraining data and employing a much smaller backbone. This indicates the power of knowledge, showing that every bit of expert domain knowledge is valuable.

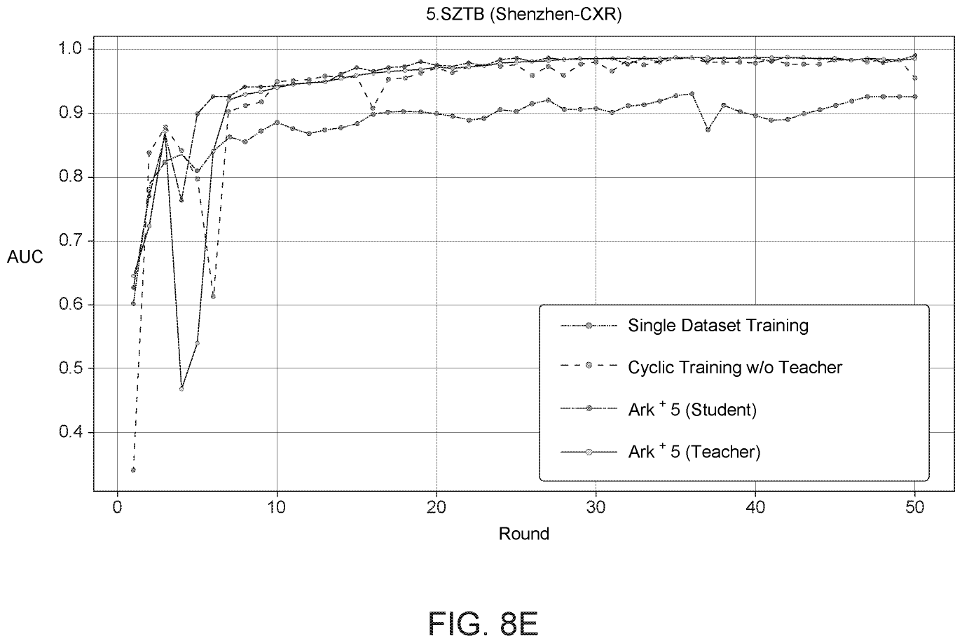

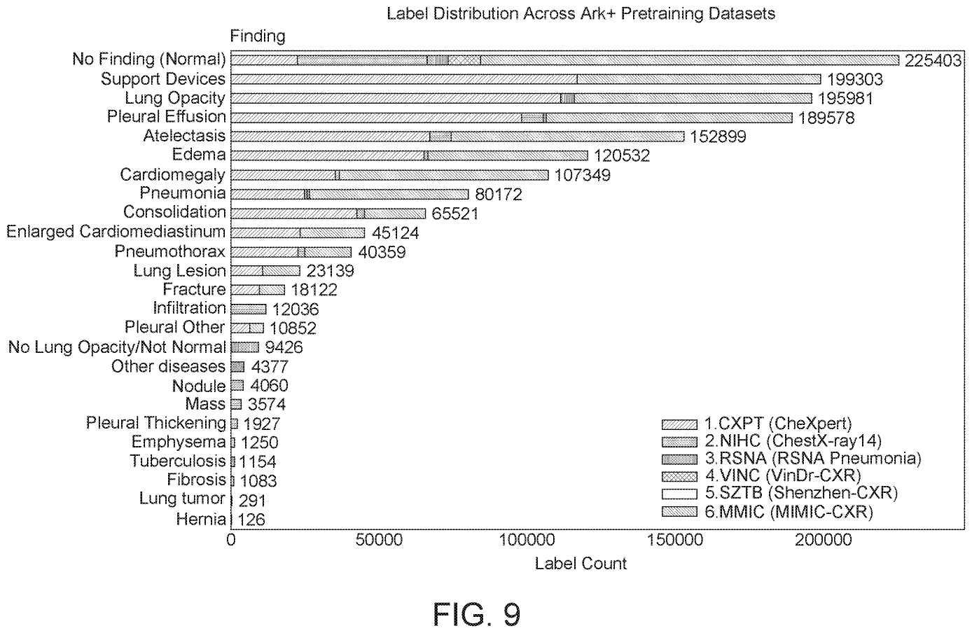

Nevertheless, since Ark+ is pretrained on a wide range of public datasets using their available diagnostic labels, it inevitably inherits the long-tailed distribution of disease categories. See FIG. 9. Supplementary to FIG. 12, Table 1 and FIG. 13, Table 2, FIG. 9 visualizes the label distribution of Ark+'s pretraining samples, highlighting the heterogeneity and long-tailed nature of disease labels across different datasets. Note that 2.NIHC (ChestX-ray14) does not include an explicit “No Finding” or “Normal” label. The samples with all disease labels marked as “0” were treated as negative (i.e., no finding). To support the ablation study comparing multi-task heads with a unified single-task head, FIG. 23, Table 12 lists the manually consolidated labels derived from the diverse pretraining datasets. FIG. 9 is a stacked bar chart that illustrates the label distribution among Ark+'s pretraining samples, aggregated across Datasets 1-6 in FIG. 13. Each bar corresponds to a thoracic finding (corresponding with FIG. 23), with the different segments indicating the contribution from each dataset. Findings are sorted in descending order by total label count, with absolute total counts displayed to the right of each bar. While Ark+ demonstrates strong overall performance on 9.CHDR for diagnosing 19 thoracic diseases with long-tailed distributions, as shown in Table 15, FIG. 26, it still exhibits lower average precision (AP<10%) for three tail conditions: calcification, increased lung markings, and elevated diaphragm. These conditions not only have very few training samples for fine-tuning but were also entirely absent during Ark+'s pretraining phase. Future work could explore incorporating specialized techniques for long-tailed classification, such as re-balancing, data augmentation, or decoupling strategies, into Ark+'s pretraining pipeline.

6.2. Benefits of Aggregating Data from a Multitude of Sources Around the World

Aggregating data from a multitude of sources offers fundamental benefits for developing representative, equitable, and generalizable medical foundation models. More importantly, such aggregation transforms heterogeneity from a challenge into an asset, fostering stronger generalization and robustness.

Unlike single-institution datasets that often reflect localized patient populations and imaging protocols, multi-source aggregation incorporates datasets collected across diverse institutions, regions, and imaging systems, introducing substantial variability in patient demographics (sex, age, and race), disease prevalence, and imaging protocols. This diversity enhances population representativeness and improves model robustness to real-world variations in imaging conditions and patient cohorts. By learning from images acquired with different scanners, protocols, and population distributions, Ark+ achieves improved domain generalization and reduced sensitivity to dataset-specific biases. Furthermore, this approach mitigates demographic imbalances often present in individual datasets (e.g., FIG. 24, Table 13 and FIG. 10), thereby enhancing fairness across subpopulations and improving robustness to demographic biases, as demonstrated in Section 5.4. FIG. 10 illustrates that the aggregated dataset (dashed line) demonstrates a more balanced age composition compared with the individual datasets (ChestX-ray14, CheXpert, and MIMIC-CXR). While institutional datasets exhibit clear demographic skew (i.e., ChestX-ray14 toward middle-aged patients and CheXpert/MIMIC-CXR toward older populations), the aggregated dataset more evenly spans the full age spectrum. This highlights that aggregating multiple datasets yields a patient population that is more representative and less biased, naturally mitigating the age-related imbalance inherent in the individual datasets. Nevertheless, Ark+ is currently pretrained predominantly on data from the USA, Vietnam, and China, and thus does not yet fully capture global variability in patient populations and healthcare practices. Future work could incorporate data from broader geographic regions and clinical settings, particularly those currently underrepresented, to further enhance Ark+'s generalizability and fairness.

6.3 Advantage of Accruing Knowledge from a Spectrum of Experts Worldwide

Complementary to the benefits of data diversity, Ark+ further gains from the accumulation of diagnostic knowledge embedded in annotations provided by numerous experts worldwide. Each dataset inherently reflects the diagnostic conventions, experience, and preferences of its contributing clinicians. By leveraging labels created by a wide range of professionals, Ark+ captures a broader spectrum of diagnostic expertise and interpretative perspectives, resulting in more comprehensive and reliable knowledge representations. This diversity ensures that the model is not biased toward a single institution or region but instead reflects diverse disease prevalence and presentation patterns, promoting a more comprehensive perspective on radiographic diagnosis.

This process effectively aggregates the collective wisdom of multiple experts, leading to improved diagnostic accuracy, robustness, and reliability.

Moreover, while Ark+ implicitly learns anatomical structures and relationships through large-scale exposure to radiographic data, it currently lacks explicit encoding of structured anatomical knowledge. This limitation may hinder its performance on tasks requiring fine-grained anatomical reasoning or interpretation, capabilities radiologists are specifically trained to perform. Future work could integrate explicit anatomical priors, such as structured knowledge graphs, annotated anatomical atlases, or self-supervised anatomical pretraining. Incorporating such structured anatomical information could endow Ark+ with a deeper understanding of human anatomy, further enhancing its diagnostic precision, adaptability, and clinical reliability.

6.4. Generalization from Classification to Localization, Segmentation, and their Integration

Although Ark+ is primarily pretrained on classification objectives, it demonstrates strong transferability to both localization and segmentation tasks by repurposing its pretrained encoder within task-specific architectures, as shown in Section 5.2. To ensure a fair comparison with baseline models and to fully leverage the model's capacity, full fine-tuning was adopted during transfer learning, despite its higher computational cost. Future work could explore parameter-efficient fine-tuning strategies, such as Low-Rank Adaptation (LoRA), to reduce computational overhead while maintaining performance.

Furthermore, Ark+'s modular architecture and task-agnostic design enable it to accommodate various task decoders and output heads tailored to different prediction formats. For example, Foundation X, an integrated framework that extends the multi-task head structure to include localization and segmentation modules, was built upon Ark+. This model was pretrained using diverse expert-level annotations (i.e., classification labels, localization bounding boxes, and segmentation masks) from 11 public datasets. These results underscore the generalization of the Ark⁺ framework in supporting a wide range of vision tasks, including more complex modalities such as 3D abdominal CT segmentation. Future work could explore deeper integration of multi-functional capabilities across even more diverse data modalities, potentially unifying classification, localization, segmentation, and other vision tasks within a single, extensible framework.

### 6.5. Potential to Handle Heterogeneous Annotations in Federated Learning

Federated learning (FL), since its inception, has been designed to address situations where multiple clients with homogeneous data collaboratively train a single global model while adhering to specific privacy constraints. By contrast, Ark⁺ accrues and reuses knowledge from heterogeneous expert annotations across numerous public datasets (without privacy concerns) for centralized pretraining of foundation models transferable to application-specific target tasks. Ark⁺ introduces the design of multi-task heads via cyclic pretraining to handle heterogeneous annotations, which has the potential to overcome the homogeneous limitation with conventional FL, enabling the use of heterogeneous annotations across private clients in FL. This hypothesis has been validated by distributing Ark⁺ to multiple clients. Each client was responsible for training a local Ark⁺ model with its proprietary data and sharing the student model weights with the central server for model aggregation, as illustrated in FIG. 1B. The experimental results in Section 5.5 confirm that Ark⁺ effectively supports distributed training across multiple clients using their proprietary data and heterogeneous annotations. This approach not only preserves data privacy but also leverages the computational resources of multiple clients, potentially making federated learning more effective in handling heterogeneous annotations.

In the distributed Ark+ implementation, the simplest form of model aggregation using weight averaging was adopted. Future work could explore incorporating more advanced aggregation techniques to further enhance model performance and strengthen privacy protection.

### 6.6. Potential to Mitigate Catastrophic Forgetting in Continual Learning

Continual learning (CL) aims to incrementally accumulate knowledge from sequential tasks without requiring retraining from scratch for each new task. It typically assumes that, during the training of a given task until convergence, data from previous or future tasks are no longer accessible. However, Ark+ has a different aim: pretraining one model with all available datasets and all accessible annotations at hand. Even when a new task is dynamically introduced on-the-fly for incremental learning (the task-scalable property described in Section 2.5), Ark+ retains access to previously seen tasks and performs cyclic pretraining across both new and old tasks. This task revisitation strategy functions as a form of rehearsal, naturally mitigating forgetting of prior knowledge. Additionally, the teacher model, updated via an EMA of the student model at the completion of each task, acts as a repository of historical knowledge. By incorporating a consistency loss between the student and teacher outputs, Ark+ transfers this accumulated knowledge back to the student as a form of implicit supervision, further reducing catastrophic forgetting during training. In summary, Ark+ and CL both reuse knowledge learned from previous tasks, but they are largely orthogonal in design objectives and applied in different settings: Ark+ aims for pretraining superior and robust generic source (foundation) models transferable to various target tasks, while CL focuses on tuning (existing) pretrained models to new specific tasks at hand.

Although Ark+ is not explicitly developed for CL, its strategy of storing accumulated knowledge in an EMA-updated teacher model and using teacher-student consistency as a regularization mechanism to mitigate forgetting offers valuable insights that could inspire future CL research. Future work could explore adapting Ark+ for more constrained continual learning settings where access to previous task data is restricted. For example, incorporating the teacher-student consistency in active continual learning is expected to further reduce annotation cost.

### 7. RELATED WORK

Ark+ is built on the core idea of aggregating various (big or small and public or private) datasets to enlarge and diversify training data while leveraging the expert knowledge embedded in heterogeneous labels. This approach enhances model robustness and generalizability, and also supports distributed training across multiple clients using proprietary data, demonstrating Ark+'s potential to support heterogeneous annotations in federated learning settings. In this work, several open foundation models were developed for chest radiography that achieve superior and robust performance compared to fully supervised and self-supervised (SSL) SOTA models, including Google CXR-FM. To facilitate a comprehensive understanding of the advancements and unique contributions of Ark+, related work in the following areas was reviewed: (1) assembling heterogeneously labeled datasets for medical imaging, (2) federated learning, (3) foundation models for chest radiography, and (4) related work.

### 7.1 Assembling Heterogeneously Labeled Datasets for Medical Imaging

Assembling heterogeneously labeled datasets for medical imaging tasks involves consolidating data from various sources to enhance the robustness and generalizability of machine learning models. This approach leverages data that reflects the diversity of patient populations and diagnostic standards, promoting the development of models that are more adaptable and accurate. Several existing methods have explored this direction. For instance, Zhu et al. 2022, “Assembling existing labels from public datasets to diagnose novel diseases: COVID-19 in late 2019,” NeurIPS Workshop Med. Imaging Meets NeurIPS, proposed a Label-Assemble strategy that assembles existing labels from public datasets to diagnose novel diseases. This approach requires a pre-defined label list, which must be updated and extended when new tasks or labels arise. Specifically, if any new labels are not in the original list, the label list must be updated, and the adapter must be retrained to accommodate these additions. Zhang et al. (2021), “DoDNet: learning to segment multi-organ and tumors from multiple partially labeled datasets,” In: Proceedings of the IEEE/CVF Conference on Computer Vision and Pattern Recognition, pp. 1195-1204, introduced DoDNet, a framework for segmenting seven organs and/or tumors using three partially labeled datasets. Similarly to Label-Assemble, DoDNet relies on a pre-defined task list. Adding new tasks necessitates updating the list, and retraining the controller to integrate the additional information effectively. Liu et al. (2023), “Clip-driven universal model for organ segmentation and tumor detection,” In: Proceedings of the IEEE/CVF International Conference on Computer Vision, pp. 21152-21164, developed a universal model driven by CLIP for organ segmentation and tumor detection. This method requires manual design of prompts to obtain CLIP embeddings for each class. When new classes are introduced, the corresponding embeddings must be regenerated and the controller retrained, resulting in additional manual effort and computational overhead.

Ark+ diverges from these methods by being task-agnostic and not requiring prior knowledge or manual interpretation of label semantics in public datasets. It is designed with pluggable multi-task heads and cyclic pretraining, utilizing all readily accessible labels directly without the need for manual consolidation or predefined lists. When a new task is introduced, a new head can be seamlessly added to Ark+ without modifying the rest of the architecture. This design ensures flexibility, scalability, and efficiency in incorporating new tasks, substantially reducing both annotation and engineering burdens.

### 7.2 Federated Learning

Federated Learning (FL) is an emerging paradigm that enables the training of machine learning models across multiple decentralized clients that hold local data samples, without exchanging their data. McMahan et al. (2017), “Communication-efficient learning of deep networks from decentralized data,” In: Artificial Intelligence and Statistics. PMLR, pp. 1273-1282, first proposed this concept and presented a practical method based on iterative model averaging, which allows the model to be trained locally while only aggregating the learned updates on a central server, thereby maintaining data privacy and security. Since its inception, FL has focused on enabling multiple clients, each with homogeneous data, to collaboratively train a single global model under specific privacy constraints. However, in practice, FL often encounters data heterogeneity, which presents a much greater challenge. SSL can naturally process images from different sources by ignoring associated expert annotations, thus learning from heterogeneous data. However, such approaches forfeit the opportunity to learn from expert annotations, which convey valuable knowledge.

Ark+ utilizes heterogeneous expert annotations from public data without concerns regarding data privacy and employs centralized training, which typically offers better performance with the same amount of data and annotations, compared with distributed training, as in FL. While the default setting of Ark+ is centralized pretraining, it has been adapted for the distributed training environment. Using the basic weight averaging operation, the effectiveness of Ark+ when distributing proprietary data and local training across multiple clients was validated, underscoring Ark+'s potential to support heterogeneous annotations across private clients in an FL setup.

### 7.3 Foundation Models for Chest Radiography

Foundation models, as defined by Bommasani et al. (2021), “On the opportunities and risks of foundation models, arXiv:2108.07258, are large-scale artificial intelligence models pretrained on massive datasets and adaptable to a wide range of downstream tasks. In healthcare, foundation models have shown promising success across various domains, including language, vision, bioinformatics, and multi-modal learning. Among these, vision foundation models have demonstrated remarkable potential in medical imaging, offering unprecedented performance across various applications. Chest radiography, being the most commonly performed radiologic examination, has resulted in the accumulation of vast amounts of imaging data, providing ample fuel for the development of vision foundation models.

To leverage large-scale medical images from diverse datasets while circumventing the challenge of annotation heterogeneity, most foundation models were developed using established SSL methods, such as contrastive learning, self-distillation, masked image modeling, and their combination, to learn general representations without using expert annotations. For example, Xie et al. (2022a), UnimiSS: universal medical self-supervised learning via breaking dimensionality barrier,” In: European Conference on Computer Vision. Springer, pp. 558-575, proposed UniMiSS, a universal medical SSL framework that alternately learns from 2D CXRs and 3D CT scans using self-distillation via teacher-student consistency. Perez-Garcia et al. (2025), “Exploring scalable medical image encoders beyond text supervision,” Nat. Mach. Intell. 7 (1), 119-130, and Moutakanni et al. (2024), “Advancing human-centric AI for robust x-ray analysis through holistic self-supervised learning,” arXiv:2405.01469, pretrained CXR foundation models on multiple public datasets using DINOv2, combining image-level contrastive learning and patch-level masked image modeling, within a student-teacher framework. Furthermore, the consistent and recurrent structure in medical images encodes rich anatomical semantics, offering strong supervisory signals for deep representation learning via self-supervision. These methods learn from anatomy by reconstructing anatomical patterns from transformed images, capturing consistent anatomical semantic patterns across patients, with subsequent enhancements via adversarial learning, exploiting spatial relationships among anatomical structures, leveraging both global and local anatomical consistency), and encoding hierarchical part-whole relationships within human anatomy. The fundamental difference between this line of work and Ark+ is that SSL does not utilize the valuable expert annotations during pretraining, thereby forfeiting disease-specific supervisory signals that can enhance representation learning.

To learn disease-specific features via expert annotations, supervised learning is typically employed for transferring or fine-tuning a foundation model that was pretrained on large-scale photographic image datasets such as ImageNet and JFT, using an individual, homogeneously labeled medical dataset, which were among the first to benchmark domain-adaptive supervised pretraining using a single, relatively large CXR dataset. Their findings showed that supervised pretraining on domain-specific data can effectively bridge the gap between ImageNet-pretrained models and the CXR domain, thereby establishing a stronger foundation for downstream tasks. Sellergren et al. (2022), “Simplified transfer learning for chest radiography models using less data,” Radiology 305 (2), 454-465, developed a CXR foundation model by initializing with a model pretrained on large-scale non-medical images, followed by supervised contrastive pretraining on several large public and private CXR datasets from the US and India. To address the label heterogeneity, granular disease annotations from the original datasets were converted into coarse “abnormal vs. normal” labels.

Ark+ advances this line of research by developing open foundation models for chest radiography using the heterogeneous expert labels associated with diverse public datasets sourced from different regions and institutions. In contrast to most prior work, Ark+ employs a fully supervised learning approach that directly utilizes the expert-provided annotations, rather than simplifying or discarding them. By fully leveraging the valuable diagnostic knowledge embedded in the heterogeneous labels, Ark+ is naturally expected to offer superior and robust performance. Its design capitalizes on the diversity of both patient populations and annotation styles, enhancing diagnostic capability, representation richness, and model generalizability across healthcare settings.

### 7.4. Related Work

Ma et al. (2023), “Foundation Ark: accruing and reusing knowledge for superior and robust performance.” In: International Conference on Medical Image Computing and Computer-Assisted Intervention. Springer, pp. 651-662, first developed an Ark framework for training foundation models by accruing and reusing knowledge embedded in heterogeneous expert annotations with numerous datasets, addressing the challenge of (supervised) learning from heterogeneous labels via multi-task heads and cyclic pretraining. The disclosed embodiments substantially expand upon the preliminary version and incorporate the following notable enhancements:
1. Updating the data augmentation strategy in Ark+ (see Section 3.1) and evaluated two newly pretrained models, Ark+5 and Ark+6, demonstrating stronger performance than their previous versions in Section 5.
2. Extending the thoracic disease classification experiments to include three unseen datasets (i.e., COVIDx, ChestDR, and CXR-LT-2023), encompassing a novel disease (COVID-19) and addressing the long-tailed challenges, as part of the external evaluation in Section 5.1.
3. Examining Ark+ on disease segmentation and localization tasks (ChestX-Det), and visualizing its Grad-CAM in Section 5.2 for a more comprehensive evaluation, highlighting the generalizability and transferability of the Ark+ models.
4. Expanding sex-related bias analysis to the ChestX-ray14 dataset in Section 5.4, offering a thorough evaluation of the robustness of Ark+ and its comparison with CXR-FM.
5. Adapting the Ark+ framework to a distributed training environment across multiple clients (see Section 3.3) and validating the effectiveness of the distributed Ark+ in Section 5.5, underscoring its potential to support heterogeneous annotations across private clients in federated learning.
6. Pretraining two additional Ark+6 models using ConvNext Base and Swin Transformer Large with input resolutions of 224×224 and 768×768, respectively, with evaluation results presented in Section 5.6, highlighting Ark+'s properties of architecture-independence and scalability to higher resolutions.
7. Successfully extending the Ark+ framework to fundus photography (see Section 3.4), and comparing the performance of a pretrained Ark+6_{fundus} model with the SOTA scores on five challenges in Section 5.7, demonstrating Ark+'s extensibility to a different imaging modality.
8. Conducting a comprehensive set of ablation studies to evaluate the contributions of three key components in Ark+ and examining the influence of two additional factors on its overall performance, with results and analysis presented in Section 5.8.

This disclosure is the culmination of a technological investigation into methodology for fully supervised learning from heterogeneous labels associated with numerous (big or small and public or private) datasets. In complementarity to this disclosure, to demonstrate the clinical value of this significant technological advancement, Ma et al. (2025) most recently evaluated Ark+6_{Large} across eight clinically relevant scenarios, demonstrating its superior generalizability, adaptability, robustness, and extensibility compared with other CXR foundation models. Furthermore, the idea underlying Ark+ has been extended from classification to support localization, segmentation, and their integration.

### 8. CONCLUSION

This disclosure presents Ark+, a framework that is designed to develop open foundation models from numerous datasets (public or private and big or small) by accruing and reusing knowledge embedded in their heterogeneous expert annotations. In implementing Ark+, several foundation models have been pretrained for chest radiography and fundus photography, demonstrating Ark+'s significantly improved performance compared with the SOTA models and Google CXR-FM across a wide range of imaging tasks, including classification, segmentation, and localization, via fine-tuning, linear probing, and bias analysis. Ark+ was also simulated in various distributed training environments, showcasing its ability to incorporate privacy-preserving data and handle heterogeneous annotations across private clients in federated learning.

Technically, Ark+ is significant in that it removes a longstanding barrier to training one model in a fully supervised fashion with a multitude of heterogeneously labeled datasets, serving as a generic source (foundation) model that is robust, generalizable, and transferable to application-specific target tasks. Ark+ is innovative owing to its several distinctive and advantageous properties: (1) knowledge-centric (focusing on integrating, accumulating, and reusing expert knowledge embedding in all accessible expert annotations), (2) annotation-heterogeneous (learning from inconsistently labeled datasets with varied annotation standards and granularity), (3) label-agnostic (requiring no standardization and consolidation of expert labels and their definitions), (4) task-scalable (supporting flexible and scalable task expansion via pluggable multi-task heads), (5) function-extensible (enabling extension from classification to localization, segmentation and their integration), (6) prediction-extensive (expanding the predictive scope beyond any single dataset) (7) training-distributable and (8) client-expandable (supporting distributed training with proprietary data and the integration of new clients mid-training), (9) architecture-independent (10) resolution-scalable (accommodating evolving model architectures and input resolutions), (11) modality-neutral (generalizing across medical domains, specialties, and data types), and (12) application-versatile (adapting across diseases, anatomies, and imaging modalities).

Clinically, Ark+ is also valuable—not only does Ark+ expand the diagnostic scope, correct potential misdiagnoses, and tolerate data biases and long-tailed distributions, but it also can adapt to evolving diagnostic needs, respond to novel diseases, learn rare conditions from a few samples, and transfer to new diagnostic settings without retraining. This exceptional capability of Ark+ in diagnosing common, rare, and novel thoracic conditions is attributable to the technical ingenuity presented in this article: cyclically training a student-teacher model through accruing and reusing knowledge from heterogeneous labels across numerous datasets, based on a simple yet powerful insight: aggregating various datasets naturally diversifies patient populations and acquires knowledge from a broad spectrum of experts worldwide, thereby offering outstanding performance while simultaneously minimizing annotation costs.

Ark+ will exert an important impact on the development of open AI foundation models for medical imaging. With all code and pretrained Ark+ models released, it is expected that its full openness will facilitate public benchmarking, rapid replication, smooth adoption, and collaborative extension. Through its annotation-heterogeneous and label-agnostic properties, Ark+ will empower researchers to best utilize their expertise and creativity in designing and annotating datasets as they deem most appropriate for their specific tasks, without conforming to existing label taxonomies, leading to new annotation standards and granularities. By virtue of its distributability in training, expandability in clients, and extensibility in function, Ark+ enables the development of foundation models with comprehensive functions covering classification, localization, and segmentation at large scales. Owing to the extensiveness of its prediction, Ark+ automatically turns limited, narrow, and partial labels from diverse experts into enlarged, broad, comprehensive predictions through its multi-task heads, expanding diagnostic scopes, correcting potential misdiagnosis, and realizing collaborative and complementary annotations among many experts world-wide. Further in light of its independence in architecture and neutrality in modality, it is anticipated that Ark+ will foster future collaborative developments of Ark+ Specialists for particular organs (e.g., brain and fundus), specialties (e.g., pathology and dermatology), and modalities (e.g., CT and MRI) and Ark+ Generalists for medicine trained with multimodal clinical data including text, tables, audios, images, and videos from various specialties. Such Generalists are not traditional “generalists” but rather versatile Specialists and foreseen to have expertise above the level of Specialists across specialties.

AI research is currently dominated by big tech companies. Accruing and reusing knowledge from heterogeneous expert annotations associated with (even only) public datasets could surpass the performance of proprietary models trained on unusually large data. As heterogeneous data and labels continue to proliferate across disciplines—from biology and chemistry to physics, medicine, and the social sciences—the concept underlying Ark+ is poised to exert far-reaching influence beyond imaging, thanks to its neutrality in modality and independence in architecture. The development of Ark+ shows that academic research labs can still make significant contributions that are fundamental to AI research through open science.

Table 14 presented in FIG. 25 illustrates disaggregate results on 2.NIHC (ChestX-ray14). It shows the detailed classification performance of Ark+, MIM-CXR, and CXR-FM on the official test set of 2.NIHC (ChestX-ray14) for diagnosing 14 thoracic conditions under both linear probing and fine-tuning settings. The table reports the mean and standard deviation (mean±s.d.) of AUC across 10 independent trials.

Table 15 presented in FIG. 26 illustrates disaggregate results on 9.CHDR to provide disease-specific performance insights. It shows the detailed classification performance comparison of Ark+ with the supervised ImageNet model and MIM-CXR on the unseen 9.CHDR (ChestDR) dataset for diagnosing 19 long-tailed thoracic diseases. The table reports mean performance over 10 trials for overall (as shown in FIG. 16, Table 5), head, tail findings, and per-finding metrics, along with sample counts. Performance gains of Ark+ over the supervised ImageNet model (vs. Sup.) and MIM-CXR (vs. MIM) are highlighted with “+” (positive) and “−” (negative).

The FROC curves shown in FIG. 4A measure the localization performance of different models. It describes the rate of true detections of localized lesions against the false positive rate on a per-image basis. Table 16 presented in FIG. 27 illustrates the sensitivity values at different false positive per image (FP/img) operating points derived from the FROC curves. The results demonstrate that Ark+6 outperforms other models across all FP/img operating points, achieving the highest sensitivity values. This highlights the superior performance of Ark+6 in accurately detecting true positives while maintaining low false positive rates. Sensitivity values at corresponding false positive per image (FP/img) operating points, derived from the FROC curves in FIG. 4A. Higher sensitivity values indicate better performance. It is preferable to achieve higher sensitivity values with as few false positives per image as possible.

FIG. 28, Table 17 is an overview of fundus photography datasets and tasks used for pretraining and evaluating Ark+6_{Fundus}. To extend Ark+ beyond chest radiography, Ark+6_{Fundus}, a specialized variant pretrained on fundus photography was developed, demonstrating Ark+'s modality-neutral property. This model was trained using 210,898 images collected from six publicly available datasets, as detailed in FIG. 28. For external evaluation, three additional unseen datasets were also included, which are also listed in the table.

What is claimed is:

1. A computer-implemented method for accruing and reusing information obtained from heterogeneously annotated labels associated with a plurality of medical image datasets to pretrain a machine learning model, comprising:
receiving the plurality of medical image datasets with the associated heterogeneously annotated labels;
cyclically pretraining the model via a student encoder of a student-teacher learning model by iterating sequentially through the plurality of medical image datasets each round of pretraining to accrue knowledge from the associated heterogeneously annotated labels; and
updating a teacher encoder of the student-teacher learning model each round of pretraining based on the student encoder's accrued knowledge.

2. The computer-implemented method of claim 1, wherein updating a teacher encoder of the student-teacher learning model each round of pretraining based on the student encoder's accrued knowledge comprises updating the teacher encoder of the student-teacher learning model using an exponential moving average (EMA) each round of pretraining based on the student encoder's accrued knowledge.

3. The computer-implemented method of claim 1, further comprising introduce a projector to map outputs of the student encoder and the teacher encoder into a shared feature space.

4. The computer-implemented method of claim 1, wherein receiving the plurality of medical image datasets with the associated heterogeneously annotated labels comprises a plurality of client nodes each receiving a respective portion of the plurality of medical image datasets with the associated heterogeneously annotated labels.

5. The computer-implemented method of claim 4, wherein cyclically pretraining the model via the student encoder of the student-teacher learning model by iterating sequentially through the plurality of medical image datasets each round of pretraining to accrue knowledge from the associated heterogeneously annotated labels, comprises the plurality of client nodes each cyclically pretraining the model via a respective student encoder of a respective student-teacher learning model by iterating sequentially through the respective portion of the plurality of medical image datasets each round of pretraining to accrue knowledge from the associated heterogeneously annotated labels.

6. The computer-implemented method of claim 5, wherein updating the teacher encoder of the student-teacher learning model each round of pretraining based on the student encoder's accrued knowledge, comprises the plurality of client nodes each updating a respective teacher encoder of the respective student-teacher learning model each round of pretraining based on the respective student encoder's accrued knowledge.

7. The computer-implemented method of claim 6, further comprising:
transmitting student weights from each of the plurality of client nodes to a central server;
calculating a weighted average at the central server to aggregate the models from each client node into a aggregated master model, thereby synthesizing diverse knowledge from the plurality of clients; and
distributing the aggregated master model to each the client nodes through subsequent iterations of cyclically pretraining the model.

8. A system comprising:
a memory to store instructions;
a processor to execute the instructions stored in the memory to perform the following operations:
receiving a plurality of medical image datasets with associated heterogeneously annotated labels;
cyclically pretraining a model via a student encoder of a student-teacher learning model by iterating sequentially through the plurality of medical image datasets each round of pretraining to accrue knowledge from the associated heterogeneously annotated labels; and
updating a teacher encoder of the student-teacher learning model each round of pretraining based on the student encoder's accrued knowledge.

9. The system of claim 8, wherein updating a teacher encoder of the student-teacher learning model each round of pretraining based on the student encoder's accrued knowledge comprises updating a teacher encoder of the student-teacher learning model using an exponential moving average (EMA) each round of pretraining based on the student encoder's accrued knowledge.

10. The system of claim 8, further comprising introducing a projector to map outputs of the student encoder and the teacher encoder into a shared feature space.

11. The system of claim 8, wherein receiving the plurality of medical image datasets with the associated heterogeneously annotated labels comprises a plurality of client nodes each receiving a respective portion of the plurality of medical image datasets with the associated heterogeneously annotated labels.

12. The system of claim 11, wherein cyclically pretraining the model via the student encoder of the student-teacher learning model by iterating sequentially through the plurality of medical image datasets each round of pretraining to accrue knowledge from the associated heterogeneously annotated labels, comprises the plurality of client nodes each cyclically pretraining the model via a respective student encoder of a respective student-teacher learning model by iterating sequentially through the respective portion of the plurality of medical image datasets each round of pretraining to accrue knowledge from the associated heterogeneously annotated labels.

13. The system of claim 12, wherein updating the teacher encoder of the student-teacher learning model each round of pretraining based on the student encoder's accrued knowledge, comprises the plurality of client nodes each updating a respective teacher encoder of the respective student-teacher learning model each round of pretraining based on the respective student encoder's accrued knowledge.

14. The system of claim 13, further comprising:
transmitting student weights from each of the plurality of client nodes to a central server;
calculating a weighted average at the central server to aggregate the models from each client node into a aggregated master model, thereby synthesizing diverse knowledge from the plurality of clients; and
distributing the aggregated master model to each the client nodes through subsequent iterations of cyclically pretraining the model.

15. A non-transitory computer readable storage media having instructions stored thereupon that, when executed by a system having at least a processor and a memory therein, cause the processor to perform the following operations:
receiving a plurality of medical image datasets with associated heterogeneously annotated labels;
cyclically pretraining a model via a student encoder of a student-teacher learning model by iterating sequentially through the plurality of medical image datasets each round of pretraining to accrue knowledge from the associated heterogeneously annotated labels; and
updating a teacher encoder of the student-teacher learning model each round of pretraining based on the student encoder's accrued knowledge.

16. The non-transitory computer readable storage media of claim 15, wherein updating a teacher encoder of the student-teacher learning model each round of pretraining based on the student encoder's accrued knowledge comprises updating a teacher encoder of the student-teacher learning model using an exponential moving average (EMA) each round of pretraining based on the student encoder's accrued knowledge.

17. The non-transitory computer readable storage media of claim 15, wherein receiving the plurality of medical image datasets with the associated heterogeneously annotated labels comprises a plurality of client nodes each receiving a respective portion of the plurality of medical image datasets with the associated heterogeneously annotated labels.

18. The non-transitory computer readable storage media of claim 17, wherein cyclically pretraining the model via the student encoder of the student-teacher learning model by iterating sequentially through the plurality of medical image datasets each round of pretraining to accrue knowledge from the associated heterogeneously annotated labels, comprises the plurality of client nodes each cyclically pretraining the model via a respective student encoder of a respective student-teacher learning model by iterating sequentially through the respective portion of the plurality of medical image datasets each round of pretraining to accrue knowledge from the associated heterogeneously annotated labels.

19. The non-transitory computer readable storage media of claim 18, wherein updating the teacher encoder of the student-teacher learning model each round of pretraining based on the student encoder's accrued knowledge, comprises the plurality of client nodes each updating a respective teacher encoder of the respective student-teacher learning model each round of pretraining based on the respective student encoder's accrued knowledge.

20. The non-transitory computer readable storage media of claim 19, further comprising:
transmitting student weights from each of the plurality of client nodes to a central server;
calculating a weighted average at the central server to aggregate the models from each client node into a aggregated master model, thereby synthesizing diverse knowledge from the plurality of clients; and
distributing the aggregated master model to each the client nodes through subsequent iterations of cyclically pretraining the model.
